(19) United States
(12) Patent Application Publication
(10) Pub. No.: US 2010/0231547 A1
(43) Pub. Date: Sep. 16, 2010

(54) RECONFIGURABLE TACTILE CONTROL DISPLAY APPLICATIONS

(76) Inventor: Timothy R. Pryor, Windsor (CA)

Correspondence Address: WARNER NORCROSS & JUDD LLP, 900 FIFTH THIRD CENTER, 111 LYON STREET, N.W., GRAND RAPIDS, MI, 49503-2487, US

(21) Appl. No.: 12/748,666

(22) Filed: Mar. 29, 2010

Related U.S. Application Data
(63) Continuation of application No. 11/832,134, filed on Aug. 1, 2007.
Application No. 11/832,134 is a continuation-in-part of application No. 11/349,350, filed on Feb. 8, 2006.
Application No. 11/349,350 is a continuation-in-part of application No. 11/319,807, filed on Dec. 29, 2005, now Pat. No. 7,671,851.
Application No. 11/319,807 is a continuation-in-part of application No. 11/184,076, filed on Jul. 19, 2005, now Pat. No. 7,466,843.
Application No. 11/184,076 is a continuation-in-part of application No. 11/045,131, filed on Jan. 31, 2005.
Application No. 11/045,131 is a continuation-in-part of application No. 10/934,762, filed on Sep. 7, 2004.
Application No. 10/934,762 is a continuation-in-part of application No. PCT/US04/09701, filed on Mar. 31, 2004.
Application No. PCT/US04/09701 is a continuation-in-part of application No. 10/611,814, filed on Jul. 2, 2003, now Pat. No. 7,489,303.
Application No. 10/611,814 is a continuation-in-part of application No. 09/789,538, filed on Feb. 22, 2001, now Pat. No. 7,084,859.
(60) Provisional application No. 60/835,072, filed on Aug. 3, 2006.

(51) Int. Cl. G06F 3/041; G09G 5/00

(52) U.S. Cl. 345/173; 345/184; 345/7

(57) ABSTRACT

This case concerns applications of my Reconfigurable Tactile Display (RTD) invention, particularly illustrating method and apparatus in which there is no rigid connection between a projector/electro-optical sensor unit, and a screen and control surface unit used to display data and receive user touch or control inputs. In many embodiments, elimination of this rigid connection constraint allows applications where heretofore it has been difficult to provide workable or useful human interface systems. One example is in the headrest of an automobile, while another is a hospital bed where the invention provides a lightweight and very easy to clean input and viewing device for the patient.

This application is a continuation of U.S. patent application Ser. No. 11/832,134, filed Aug. 1, 2007 (now U.S. patent ______), which claims the benefit of U.S. Provisional Application 60/835,072, filed Aug. 3, 2006, and which is a continuation-in-part of U.S. patent. Ser. No. 11/349,350 (now U.S. patent ______), filed Feb. 8, 2006, U.S. patent application Ser. No. 11/319,807 (now U.S. Pat. No. 7,671,851), filed Dec. 29, 2005, U.S. patent application Ser. No. 11/184,076 (now U.S. Pat. No. 7,466,843), filed Jul. 19, 2005, U.S. patent application Ser. No. 11/045,131 (now U.S. patent ______), filed Jan. 31, 2005, U.S. patent application Ser. No. 10/934,762 (now U.S. patent ______), filed Sep. 7, 2004, PCT/US04/09701, filed Mar. 31, 2004, U.S. patent application Ser. No. 10/611,814 (now U.S. Pat. No. 7,489,303), filed Jul. 2, 2003, and U.S. patent application Ser. No. 09/789,538 (now U.S. Pat. No. 7,084,859), filed Feb. 22, 2001. The disclosures of the above patent applications are hereby incorporated by reference in their entirety.

### FIELD OF THE INVENTION

The invention is generally in the field of human-computer interfaces, instrument panels for vehicles, and control and display devices for general. Disclosed are improvements and alternative embodiments of my RTD (Reconfigurable Tactile Display) invention disclosed in co-pending applications, particularly those where the screen/control surface is not fixedly connected to a projector and optical sensor used to see finger touch and control position based command inputs. Typically, projection of displayed imagery is via rear projection, but some embodiments utilize front projection. Some embodiments may utilize the device for only sensing or only projection, but typically one wishes to both project and sense, either finger touch location, or physical control positions or states-any or all.

### BACKGROUND OF THE INVENTION

No known prior art discloses sensing of physical control locations or finger touch location using video or still image projection based systems such as the “RTD” invention I have disclosed in co-pending applications. All of the embodiments disclosed herein are totally unique to the best of my knowledge, and the background for the present invention are the current conventional methods employed in cars, planes, hospitals, appliances, cameras, keyboards and the other applications described.

### SUMMARY OF THE INVENTION

This document contains further disclosure on my RTD (Reconfigurable Tactile Display) invention generally (but not necessarily) employing a flying spot scanner based projector design, further incorporating a sensor of touch position on a surface as well as a sensor of knob and other physical control position or state, when said physical controls are on a surface (herein called the control surface) viewed by the projector/sensor unit. While the most value is when the projector operates also as a sensor, many of the ideas herein may also apply to when an embodiment is operated only as sensor, or only as a projector.

The new Microvision or Symbol Technologies miniature projectors shown at the SID conference in San Francisco in June 2006 use three semiconductor laser sources (RGB), as disclosed in some of my applications. These enable many new applications of the RTD to be effectively commercialized, especially since costs of such projectors are indicated to be as low as 100 dollars retail, and small enough to be packaged into a cell phone.

The invention herein, in one embodiment, comprehends adding a fourth color of diode laser for sensing purposes whose wavelength is in the near Infrared, but it could be deep blue or far red, (i.e. at the fringes of the visible spectrum) such that it is not seen easily by the driver of the car (or other user in a non-car case). This laser can be turned on periodically when information is required as to finger touch or knob position (or the screen and control surface location itself, if not rigidly affixed to the projector and free to move) and preferably is modulated and the appropriate detector demodulated generally in some time based manner in order to allow discrimination against ambient light, such as sunlight. One such manner is to modulate the laser (or LED) used at a high frequency and to look for return signals at the same frequency. Since sunlight in the passenger compartment of a car for example cannot change very fast, even in sweeping a shadow over the screen, it is possible to reject effects of sunlight on the front of the screen, even if they are of much more intensity than the laser sources employed, attenuated by screen effects if any as well.

In the disclosure herein, the term “projector/sensor unit” or “projector/sensor module” is meant to primarily denote this type of system, though other disclosed arrangements such as DLP based projectors with associated camera systems, or DLP projection systems run also in a sensing mode, can also form a projector/sensor unit and be used with the invention herein. Numerous types have been disclosed in the co pending applications incorporated by reference.

As an alternative to providing a special light source for the sensing, such as an IR LED or diode laser, one can also use one or more of light sources in the visible image projection system for the sensing. While visible to the user if on for too long a duration, or at too high an intensity, it can, in some cases be run in a manner not objectionable to the user. This is the lowest cost solution particularly in the near term, as it only requires minor modifications the projector unit, at least in those cases where the detector is separate.

The invention herein is an elegant solution for the RTD, and offers a chance to provide the many benefits of the RTD at a low price capable of saving considerable cost and weight in a vehicle, while improving safety and functionality. In addition, in considering my invention as it stands today and comprehended by the many applications filed, I have come to realize that it has near universal appeal to areas as diverse as homes, hospitals, aircraft, wheelchairs, digital cameras, and indeed anywhere one would want a simplified control system in combination with the largest possible image display for the available space. This is also due the fact that I have found for many persons and applications, the interruption of the image by a control such as a knob on the screen does not ruin the presentation of the image, as it might if the purpose was watching a movie on a HDTV for example. And it has unique advantages for a number of specialized applications which have been disclosed previously and which will be elaborated on here.

The invention also allows the separation of the electronic portion (projector and sensing of control and touch location) from the screen and control portion. This has numerous advantages in certain applications. For example the screen and control surface and controls attached thereto if any, can be simple, lightweight and easy to hold and clean and store or remove. The electronic portion comprising sensing and projection (as well as either individually) can be very small (a fraction the size of a small cell phone), and does not have to be the size of the screen. This allows packaging of the projector and sensor unit in all sorts of places. In addition the screen and controls can be made of unbreakable materials, with no wires to disconnect or provide an electronic hazard. The screen can even be flexible, and rolled up out of the way if desired.

Heretofore most of my disclosures have generally had some sort of rigid connection between the sensor/projector portion, and the screen/control surface portion. This application presents many more embodiments with either a completely separated projector/sensor from the screen/control surface, or embodiments where the two are not rigidly connected, but have an ability to swing, slide or otherwise move one in and out with respect to the other, while still having a mechanical linkage between them.

It is a goal of the invention to provide method and apparatus for low cost provision of reconfigurable instrument panels that are operable in all required conditions and of simple design easily learned by potential users.

It is a goal of the invention to provide method and apparatus for sensing touch locations and control detail state or position.

It is a goal of the invention to provide method and apparatus for operating a projector in a sensing mode as well as a projection mode.

It is a goal of the invention to provide method and apparatus for providing projection on a freely held screen and control surface and sensing of controls or touch positions thereon.

It is a goal of the invention to provide method and apparatus providing convenient and easy to operate reconfigurable controls and displays for persons seated in cars or airplanes.

It is a goal of the invention to provide method and apparatus which allow convenient use by the driver of a vehicle of controls and displays in the center stack of the vehicle.

It is a goal of the invention to provide method and apparatus that allow maximal display area in vehicle center stacks, digital cameras, TV remote controls and other applications.

It is a goal of the invention to provide method and apparatus for improving visibility of labels or other important information.

It is a goal of the invention to provide novel sun visor based method and apparatus for display and control use by the driver of a vehicle.

It is a goal of the invention to provide novel steering wheel based method and apparatus for display and control use by the driver of a vehicle.

It is a goal of the invention to provide a novel method of reconfiguring a keyboard of a computer and apparatus based thereon.

It is a goal of the invention to provide an improved method and apparatus for exercise which further can display entertainment information and provide control functions on the same screen and control surface.

It is a goal of the invention to provide improved appliances for the home, which can display entertainment information and provide control functions on the same screen and control surface.

It is a goal of the invention to provide an oven whose window allows presentation of TV entertainment and act as a device for reconfigurable control functions.

It is a goal of the invention to provide a window display, which allows passers by on the outside said window to control projected information from inside said window using either finger touch or physical controls sensed from inside.

It is a goal of the invention to provide method and apparatus that can provide display and control on objects, which can be removed from a vehicle or other location.

It is a goal of the invention to provide a method and apparatus for operation of controls using front projection and sensing.

It is a goal of the invention to provide method and apparatus for providing an easy to use audio or other system for a car, which fits in a double din slot in the instrument panel thereof and allows the unit to have a screen surface larger than the slot.

It is a goal of the invention to provide method and apparatus for projection and sensing which can be easily protected from theft and easily cooled, dehumidified or heated where required to function in adverse environments.

It is a goal of the invention to provide method and apparatus, which can be resistant to damage by use of hard, flexible, or otherwise suitable materials for the screen/control surface.

It is a goal of the invention to provide method and apparatus that can provide minimum shock hazard to operators under a variety of adverse conditions including those where water or other liquids are present on the control panel itself.

It is a goal of the invention to provide method and apparatus which provides a light weight screen and control surface capable of easy motorization in and out of a location, as well as for ease of removal storage and the like.

It is a goal of the invention to provide method and apparatus which is stylish and practical when built into items such as car interiors, furniture and the like which have style issues to meet. This is in part due to the ability to have shaped, non-flat screen/control surfaces, as well as to provide same from a variety of materials and textures.

It is a goal of the invention to provide method and apparatus to illustrate application of miniature projectors fitted into beds, chairs, cameras and other devices in conjunction with control panels for human interaction with data projected.

It is a goal of the invention to provide method and apparatus able to be easily removed, moved out of the way, or stored, which can provide control functions in appliances, vehicles, hospital beds, furniture, wheel chairs and other applications. It is further a goal to provide this in a safe manner which does not cause accidents or injury in the event of a crash.

It is a goal of the invention to provide method and apparatus which provides an easy to clean and maintain human interface comprising both display and controls, usable by patients or staff in hospitals, nursing homes, food preparation persons and other activities where sanitary conditions need to be maintained, while also requiring interaction with computers, and especially image based interaction.

It is an additional goal of the invention to provide means for maximizing the display space on car center stacks, digital camera backs, remote controls, and other objects where space is at a premium and must be shared with controls.

It is a further goal to provide a screen and control surface that can be sterilized.

It is a further goal of the invention to provide an efficient, low cost and maintainable means for potential customers to interact from outside a store window with computers inside the store.

Further features and advantages of the present invention will be set forth in, or apparent from, the detailed description of preferred embodiments thereof which follows.

### BRIEF DESCRIPTION OF THE DRAWINGS

FIG. 1 illustrates basic embodiments for use in an airplane seat or the rear seat of a car;

FIG. 2 is another embodiment for use in the rear seat of a vehicle;

FIG. 3A illustrates an embodiment in which a projector directly projects via front or rear projection, on a portion of a child seat, placed in the rear seat of a car;

FIG. 3B illustrates an embodiment having redirection to rear projection;

FIG. 4a illustrates a still further embodiment for use in a rear seat of a vehicle or a airplane seat;

FIG. 4b illustrates another embodiment for use in a rear seat of a vehicle or a airplane seat;

FIG. 5a illustrates an embodiment in which the projector is in the right hand side of the instrument panel illuminating a screen and control surface on the front of the panel located between the airbag and the glove box for use by the passenger in the right front seat;

FIG. 5b illustrates a similar embodiment in which the screen is in the slightly curved bolster on the back of a seat;

FIG. 6 illustrates an embodiment in the center stack of the vehicle in the instrument panel and between the two front seats in which a fold up screen/control surface is hinged to flip down into the field of view of a projector/sensor unit in the back of the center stack and pointing out ward;

FIG. 7 illustrates an embodiment employing oblique incidence illumination of center stack from below;

FIG. 8 illustrates a drawer type embodiment of the invention;

FIG. 9 illustrates a “roll top desk” embodiment of the invention;

FIG. 10 illustrates another center stack embodiment in which three projectors in an over/under arrangement are used to maximize brightness and minimize depth;

FIG. 11 illustrates a basic sensor/projector embodiment also containing features for improving visibility of labels or other important information;

FIG. 12 illustrates an embodiment with screen/control surface in the steering wheel of a vehicle with the projector/sensor module located in the steering column or instrument panel;

FIG. 13 illustrates a front projected sun visor based embodiment of the invention, wherein the projector/sensor unit is roof mounted;

FIG. 14 illustrates an embodiment of the invention in which a screen/control surface pulled down in front of the rear view minor of a vehicle;

FIG. 15A illustrates an embodiment of the invention in which the components are arranged to mount in a Double Din audio slot in a car;

FIG. 15b is a side view of the embodiment of FIG. 15A;

FIG. 16a illustrates an alternative “wedge type” embodiment in the center stack of the vehicle;

FIG. 16b illustrates a novel “wedge type” embodiment projecting through air to a curved diffuse screen and control surface in the center stack;

FIG. 17 illustrates an embodiment of the invention which makes use of the unique ability of the invention to have an easy to clean and even sterilize-able screen and control surface, in this case in a hospital bed;

FIG. 18 illustrates a microwave oven embodiment of the invention with a sliding front window which allows its use as TV display also in some cases even during cooking;

FIG. 19A illustrates an embodiment of the invention useful for appliances in general and other applications having a “flip up” screen and control surface;

FIG. 19B illustrates an embodiment of the invention useful for appliances in general and other applications having a screen and control surface built into a working surface of an appliance;

FIG. 20 illustrates an embodiment of the invention in an exercise machine, such as a treadmill, stationary bicycle, rowing machine or other machine, and further illustrates combination with other technologies for determining position of members and pulse information;

FIG. 21 illustrates a portable embodiment of the invention for use as a keyboard;

FIG. 22 illustrates another portable embodiment used as a remote control for a Video/audio system in a home (and providing a degree of video audio capability itself;

FIG. 23 illustrates a digital camera of the invention having superior data display capabilities and more user intuitive operation;

FIG. 24 illustrates a store window embodiment of the invention allowing passers by to interact with a computer system inside the store;

FIG. 25A illustrates a front projection example of the invention on the back of a car seat headrest;

FIG. 25B illustrates a second front projection embodiment of the invention and a knob control detail;

FIG. 25C illustrates a front projection embodiment with a slider control detail;

FIG. 26 illustrates a separate large knob on the outside of a store window with data displayed inside it, and touch interaction;

FIG. 27A illustrates a car window embodiment, wherein at least a portion of the window is diffuse;

FIG. 27B illustrates an embodiment with a pull down screen/control surface;

FIG. 28 illustrates an embodiment in a glass showcase;

FIG. 29a illustrates a center stack embodiment of the invention in audio system mode;

FIG. 29b illustrates a center stack embodiment of the invention in climate control system mode; and

FIG. 29c illustrates an embodiment of the invention for providing a programmably actuatable detent and/or fixed stop for working a knob.

### DESCRIPTION OF THE PREFERRED EMBODIMENTS

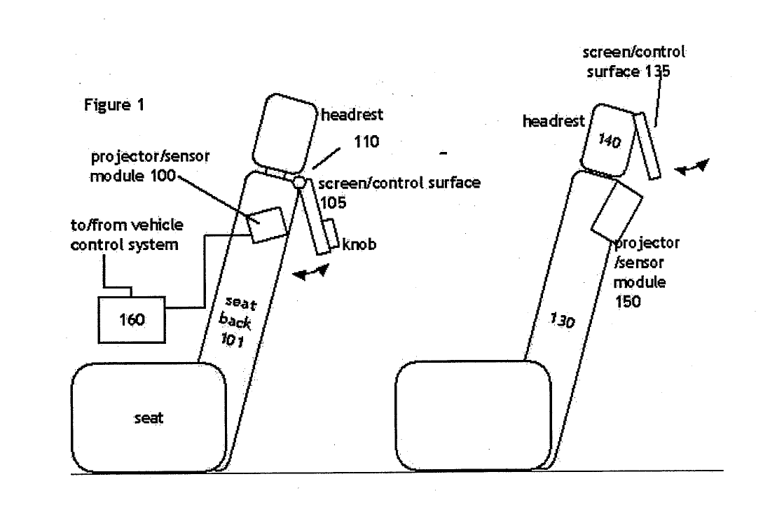

FIG. 1 is a basic embodiment for use in an airplane seat or the rear seat of a car, in which the projector/sensor unit 100 is located in the back of the seat 101 ahead of the user. The screen/and control surface 105 may be secured to the seat ahead, to ones seat, or held free form in the hand. In the case shown, it swings out from the seat ahead, using hinge 110. The projector/sensor unit is in this embodiment and in all embodiments herein (even if not explicitly shown for simplicity) connected to a computer 160 which processes the sensed data inputted by the user via physical control positions (such as knobs, sliders, switches) or by finger touch, and controls both the displayed information and the control signals transmitted in many cases to the control system of the vehicle.

Also illustrated is an embodiment in the right most seat 130 in the drawing in which a screen and control surface 135 swings out of the headrest 140 of the seat with the projector/sensor module located in the head rest, or in the top of the rear seat, or attached to the top of the rear seat as shown, and projecting obliquely onto the screen/control surface which in this instance is shown as a touch screen only, with no physical controls, though such can be provided.

Recesses in seat backs or other locations can be made where desired to accommodate the screen and control surfaces and controls such as knobs, when they are stored and out of the way of the passengers.

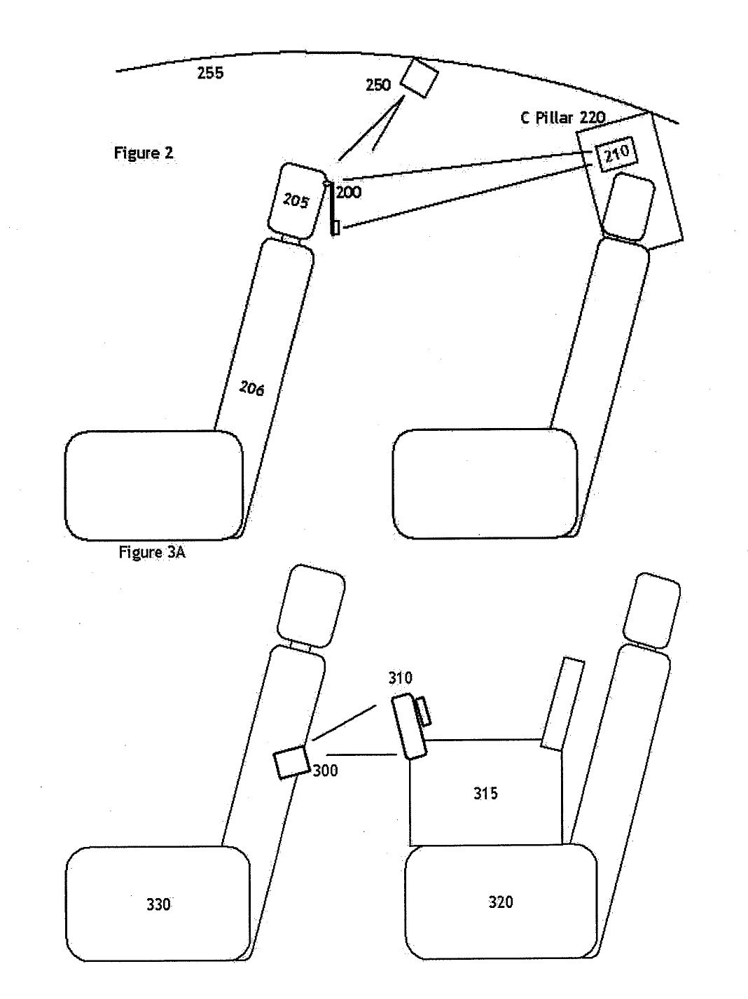

FIG. 2 is another embodiment for use in the rear seat of a vehicle (or potentially in some airplane seats) in which information is front projected on the front of a screen and control surface 200 directly on the back of a headrest 205 on the seat 206 in front of a user, or swinging out there from as shown (so as to be able to be used at different angles as desired), using a projector/sensor unit 210 located in the vehicle “C pillar” 220, which projector if desired may be used as a reading light if the angular spread of projector light is enough, or if the screen is on or near the persons lap as opposed to on the headrest as shown. An arrangement similar to the location of the sensor/projector on the c-pillar can for example, be used with the projector/sensor unit located for example at a top corner of a chair back in ones home, or in a nearby reading lamp, and having the screen and control surface on ones lap or an object positioned on ones lap. These locations can be used in vehicles too.

Alternative to location in the C pillar of the vehicle, projector/sensor unit 250 can be in the roof 255, for example such as shown in dotted lines.

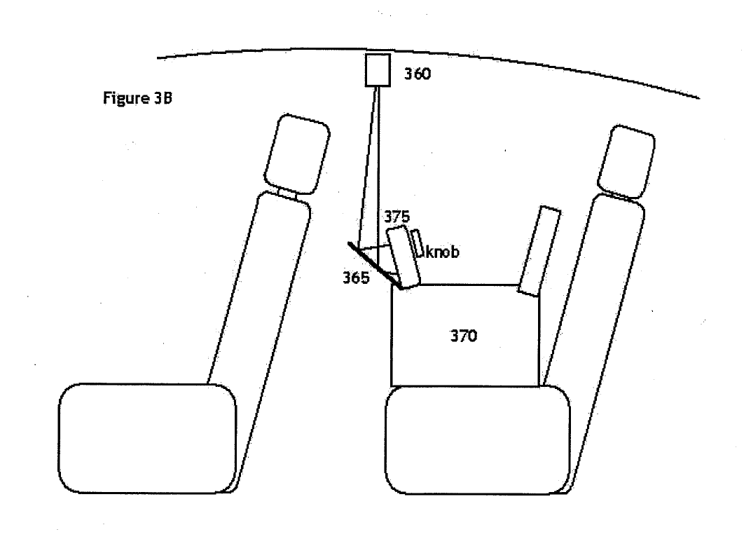

FIG. 3A illustrates an embodiment in which a projector/sensor unit 300 operates in either front or rear projection (rear being shown) on a screen/control surface portion 310 of an object which can be removed from the vehicle (or other location) such as a child seat 315 placed in the rear seat 320 of a car. In this case rear projection is illustrated using a projector/sensor unit in the seat 330 ahead. However it is noted that the projector can be in the seat on which the child seat is placed if the seat is designed accordingly, or may be in the roof or C-pillar and front projected onto the child seat.

Alternatively, as shown in FIG. 3B, a roof mounted projector sensor unit 360 may be used to project onto a minor 365 in the child seat 370 which redirects it in rear projection onto a screen and control surface 375 of the child seat. (This same re-direction to back projection technique can be used in other embodiments of the invention as well, and allows projector sensor units to be located in out of the way places, while maintaining the benefits of rear projection in terms of clarity and lack of obscuration by the hands of the user). Note that this projector can, if desired, do double duty as a limited angular spread dome light, given its roof location.

It should be noted that the invention is really of value where objects are moved in and out, since there is no physical connection required between the projector/sensor module and the screen/control surface. While illustrated here relative to a child seat, it is also of value in many other locations some of which are illustrated in this application.

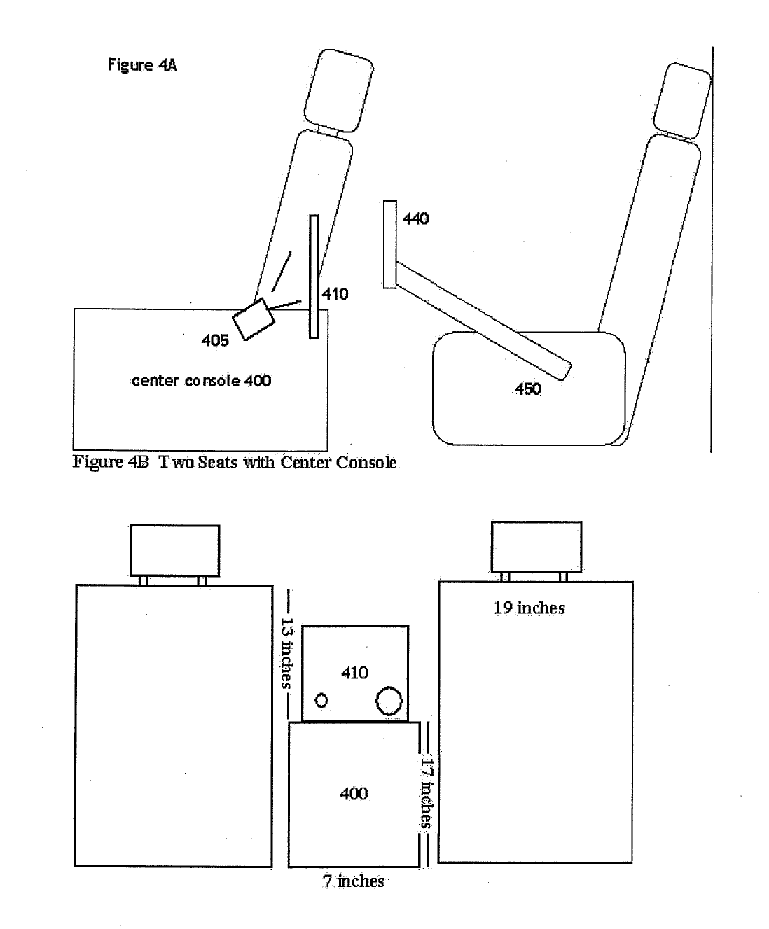

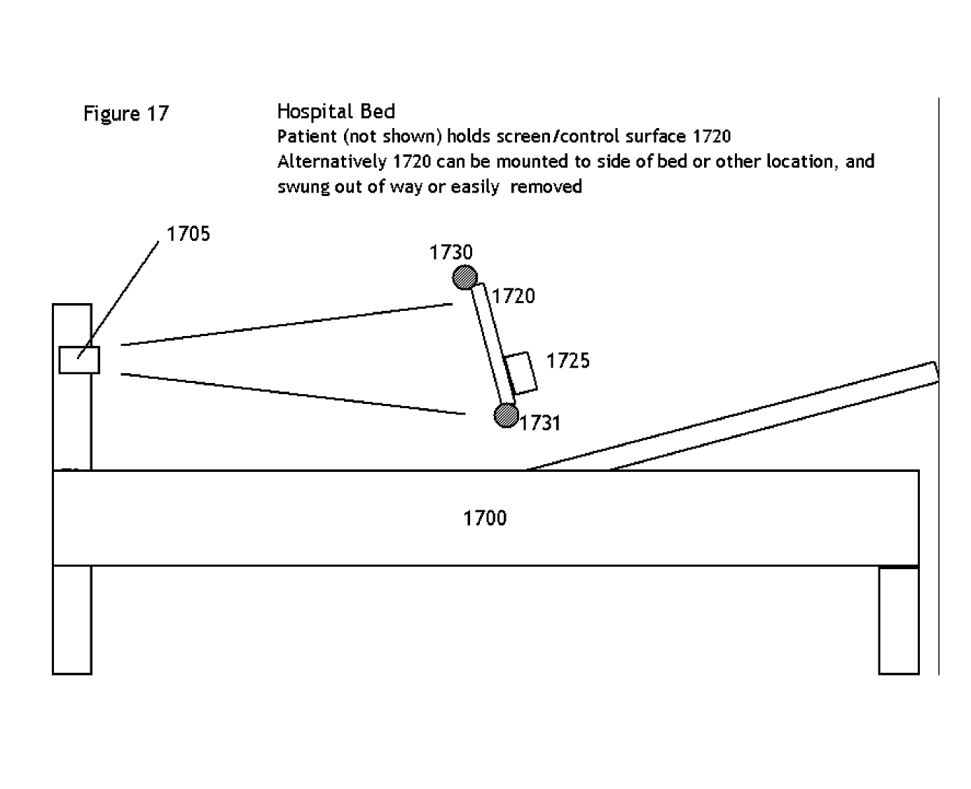

FIG. 4a illustrates an embodiment for use by persons in a rear seat of a vehicle or a airplane seat, in which a center console 400 is used to hold a projector/sensor module 405 and the Screen/Control Surface 410 is pulled up from a storage location in the console. Alternatively it may be directly attached to the console, or attached to one of the seats ahead such as 430. And further alternative is to attach the Screen/Control Surface to ones seat, such as Screen/Control Surface 440 shown attached to rear seat 450. And as a further alternative (also in other embodiments) the Screen/Control Surface can be freely held (as described below relative to FIG. 17).

FIG. 4b illustrates a fore aft view of the center console and front seats also including typical dimensions taken from a Toyota Camry.

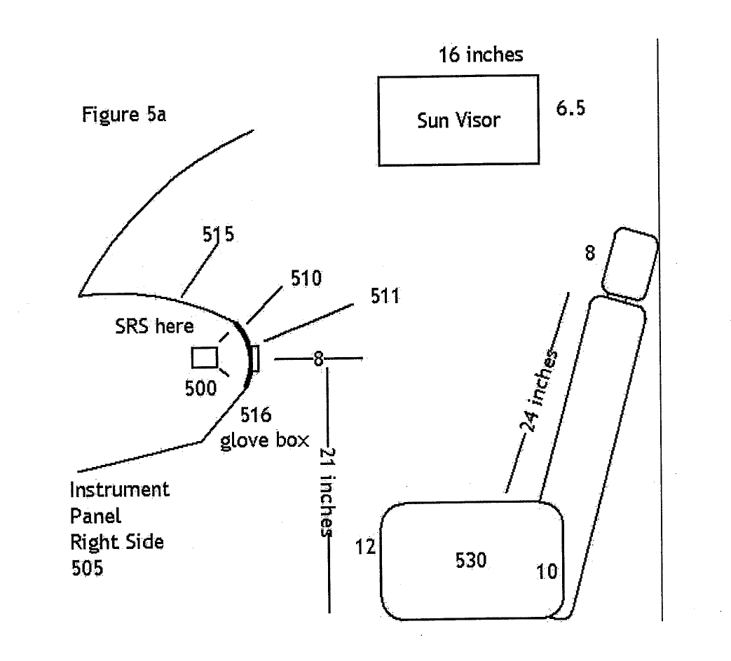

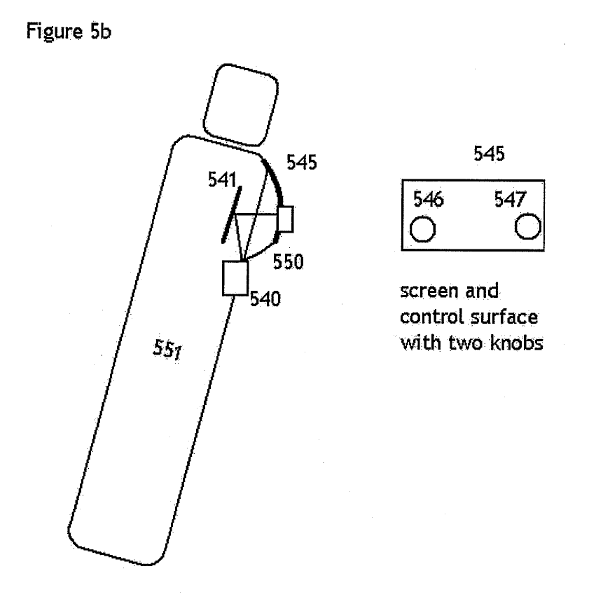

FIG. 5a illustrates an embodiment for use by the passenger in the right front seat 530 in which the projector/sensor unit 500 is in the right hand side of the instrument panel 505, rear illuminating a screen and control surface 510 curved to blend harmoniously in with the instrument panel shape and having physical controls such a knob 511 on the front of the Instrument panel located vertically between the SRS (airbag) 515 and the glove box 515. For passive safety reasons in event of a crash, the material of the screen and control surface, and the controls thereon should be compliant to the degree needed, and devoid of sharp corners. Since the screen of the device is in a known location relative to the passengers eyes, which are constrained to be within a certain volume of space, a somewhat directional “high gain” type rear projection screen design can be used, maximizing the light available to reach the passengers eyes from a small projector. It should be noted that one can have alternatively other designs of screen and control surfaces in this location, which flip up or down or to the side, examples of which are shown in other embodiments herein.

FIG. 5a further includes typical dimensions in inches taken from a Toyota Camry, further including dimensions of a typical sun visor attached to the roof. There is generally a large surface area in front of the right front seat passenger where information can be displayed, and ample room for the projector sensor unit of the invention. This area is much less constrained for space than the center stack region of the instrument panel.

FIG. 5b illustrates a similar embodiment in which a sensor/projector unit 540 in the bolster or pad 550 on the back of a seat 551 illuminates via mirror 541 a curved screen/control surface 545 having two knobs 546 and 547 for use by the rear seat passenger to control audio, HVAC or other functions.

It should be noted that the embodiments of FIGS. 5a and 5b could be provided in a front projection mode instead of rear projection.

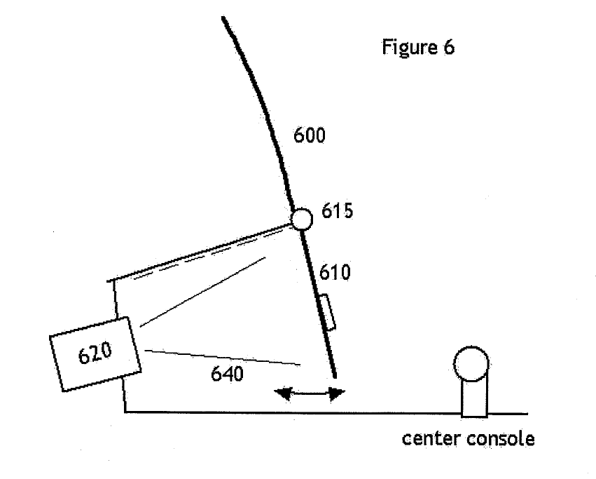

FIG. 6 illustrates an embodiment in the center stack of the vehicle in the instrument panel 600 and between the two front seats in which a fold up screen/control surface 610 is hinged by hinge 615 to flip down into the field of view of a projector/sensor unit 620 in the back of the center stack and pointing out ward toward the screen/control surface. One can appreciate that the screen could alternatively be hinged from the bottom and fold up, or it may can push in and out toward the projector too, in order to come into place. When the screen/control surface is folded position, it is not usable, but the region 640 becomes usable by the driver and passenger for storage of incidental items.

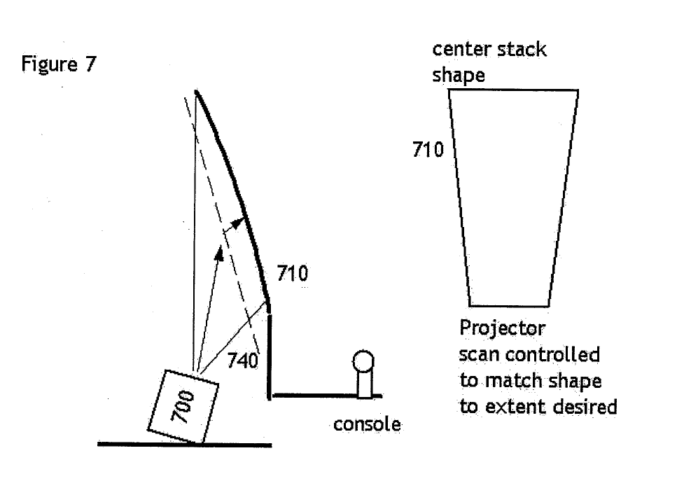

FIG. 7 illustrates an embodiment employing oblique incidence illumination from below by a projector/sensor unit 700 of a screen/control surface 710 in the center stack of an instrument panel of a vehicle. While the laser scanning projectors have a very large depth of focus, the difference in distances to the screen because of natural keystone effect where the width of the projected image at the lower portion of 710 is considerably less than at the top. However, in this case, the center stack itself has a shape naturally of less width at the bottom in many cases in order to clear the legs of the driver and passenger (especially in small cars). Thus I have found it is not necessary to correct the projected image to have identical widths top and bottom like other keystone correction devices, but only to match the desired width regions needed to illuminate and sense (where sensing is included in the device). The difference in magnification, top to bottom, which results, may also be corrected in the display software such that the lettering and other information appears the same.

For best screen performance with respect to viewing by the driver and passengers, It is often desired to have the light from the projector strike the rear projection screen at a more or less normal angle of incidence and in this case an optional Off-Axis Fresnel lens 740 can be employed as shown in dotted lines. In this case the projector output is located more or less at the focus of the Fresnel lens. For some screen types, the projector may be located near but not at the focus, in order that more light proceed thru the screen toward the driver. Special types of lenses for this have been discussed in other co pending applications.

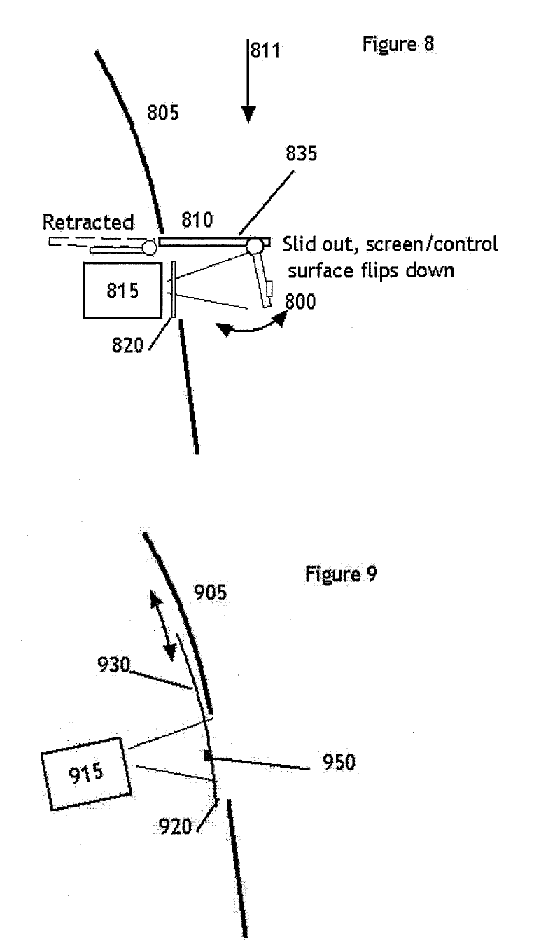

FIG. 8 illustrates a version in which the screen/control surface 800 pulls out from the instrument panel 805 on slide 810, and when extended drops down. The projector/sensor module 815 is in this case fixed in the instrument panel behind cover window 820. The upper sliding portion of the mechanism 810 masks sunlight 811 from hitting the screen/control surface 800 and the top surface 835 may additionally act as a cup holder or other device if desired. It is noted that this arrangement can also operate with the screen/control surface flipping up when the slide is extended. In this case the projector is above the mechanism such as 810 used.

This arrangement is like a drawer, and can be located at many places within the vehicle. And similar arrangements can be in desks in the home or school or office and other locations. It can have sides like a drawer as well, which can clear the projector/sensor module 815 as the drawer is pulled in and out.

FIG. 9 illustrates a “roll top desk” type of arrangement in the instrument panel 905 where the screen/control surface 920 is sufficiently flexible. The tracks can be in the sides, or the screen can be free form. This flexible nature can be used in other locations as well, such as desks, the tops of seat backs, sides of couch or easy chair arm rests and the like. Generally desirable, is to control the system such that when the screen/control surface 920 is sensed by the projector/sensor unit 915 to be in a correct location, for example by sensing the location of datum 950 in the center of the control surface, the image projection is turned on. This avoids projecting images that might be odd looking when viewed on a miss-positioned screen, or projecting them into space past the screen. When the surface 920 is moved downward, a section 930 that serves decorative or other purposes “rolls” into view through the action of a user, either manually or via a small motor.

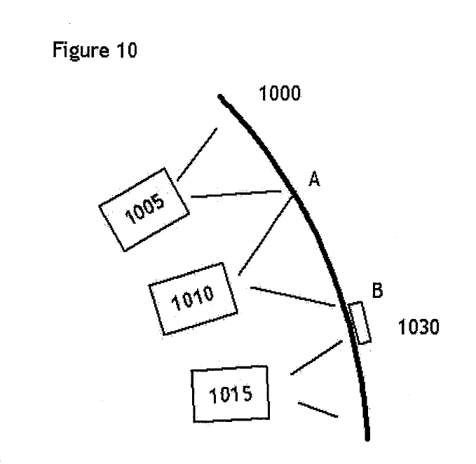

FIG. 10 illustrates another center stack embodiment in which three projector/sensor units 1005, 1010 and 1015 in an over/under arrangement are used to maximize brightness and minimize depth in a dramatic large area center stack screen/control surface 1000. Each covers a relatively smaller area in the vertical direction, allowing more brightness and less depth, which further allows in many cases one to project directly without folding the beam path. In some cases, these projectors could via beam splitting arrangements, share the same laser sources if desired. Note that the displays can be stitched together in the computer to form a large contiguous display for example at point “A”, and/or trim strips such as 1030 can be used at the display junctures if desired (particularly if as shown at point “B” the two projections don't meet). Note that by having the fast axis of scan in the vertical direction for each projector, the speed of scan required in that direction can be less, as larger scan is required in the direction out of the paper (typically by a 16:9 ratio).

This particular embodiment illustrates a version useful particularly in small cars where the instruments and gages (speedometer, fuel gage, etc) are projected in the top region and shielded a hood from sunlight. In this instance, the top projector can be optionally replaced by a conventional LCD screen if no physical controls are needed in that location, and if desired the LCD display “stitched” with that of the projector below, as disclosed in my December 2005 co pending application. Alternatively the projector could be replaced by a conventional touch screen flat panel display if one might wish conventional touch functions to be used.

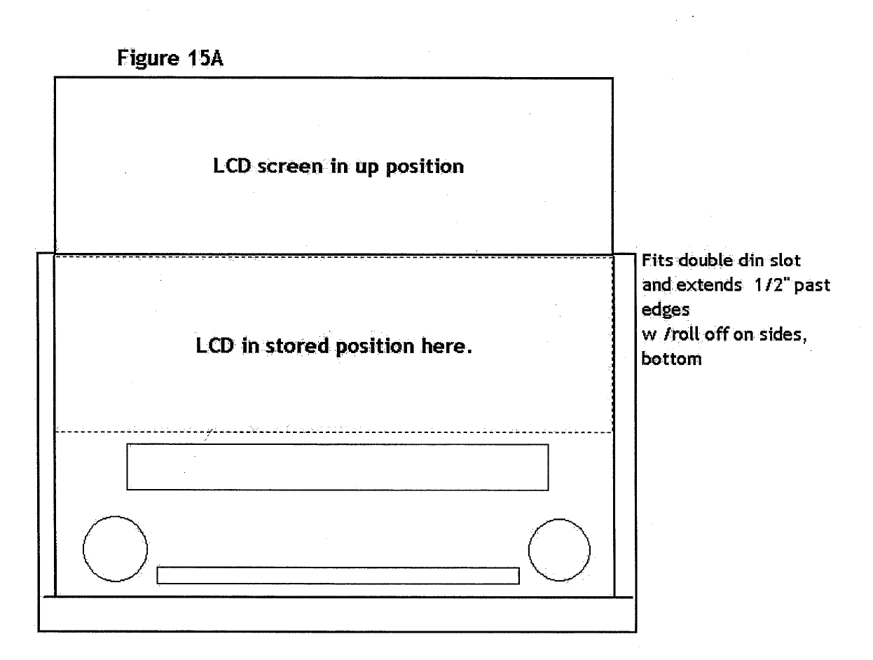

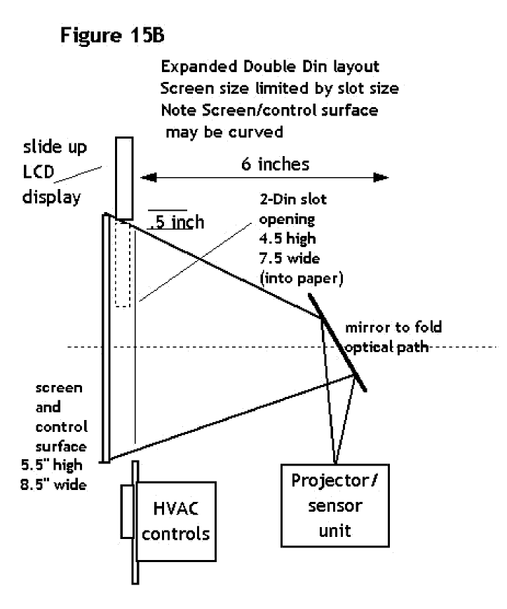

It is also noted that the bottom projector of the three may not be needed on certain vehicles that have limited function to fulfill. Indeed because the invention can reconfigure a screen and control surface to perform both audio and HVAC functions, just one projector/sensor unit can be advantageous in low cost vehicles, similar for example to the double din example of FIG. 15.

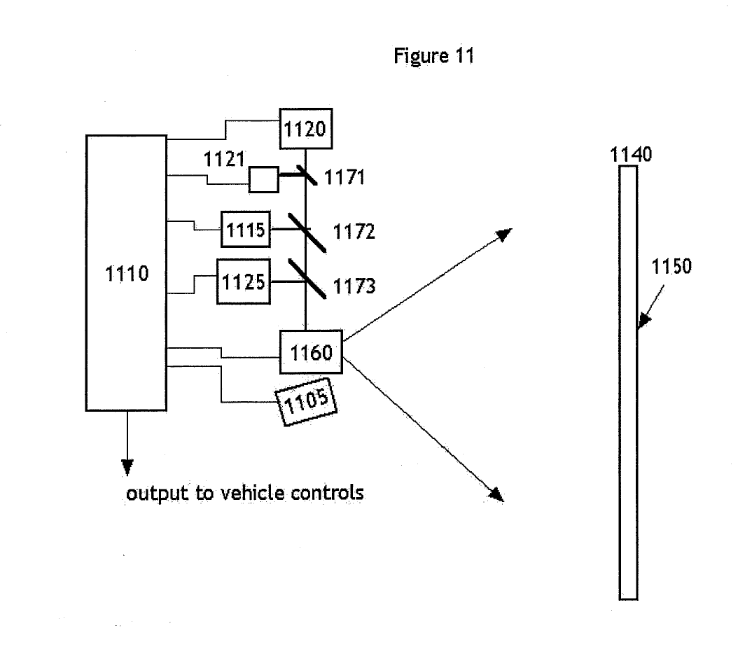

FIG. 11 illustrates a basic sensor/projector embodiment also containing features for improving brightness and general visibility of labels or other important information during conditions of sun irradiation of the screen/control surface.

Computer 1110 controls both projection and sensing. The scanning projection mirrors 1160 scan the Red green and blue combination of lasers coming from unit 1125 which have been previously combined in side 1125 in the proper proportion for the pixel to be projected on to screen and control surface 1140. An IR laser 1120, operating at for example 880 nm is scanned simultaneously with the RGB signal (the later being turned off when nothing visible is to be seen). Detector 1121 (which may have a band pass filter to reject information not at the 880 nm IR laser wavelength) in the return path picks up information as to physical control positions on the screen and control surface. Dichroic minors and beam splitters 1171, 1172 and 1173 are used, for example, to combine and direct the beams.

Sunlight or other light 1150 hitting the screen and control surface is detected in this example by a separate detector 1105 responsive in the visible. The light detected is used to control in this case wither more power or time to be spent on labels and critical information, or to turn on auxiliary laser 1115 to provided added intensity when labels are projected.

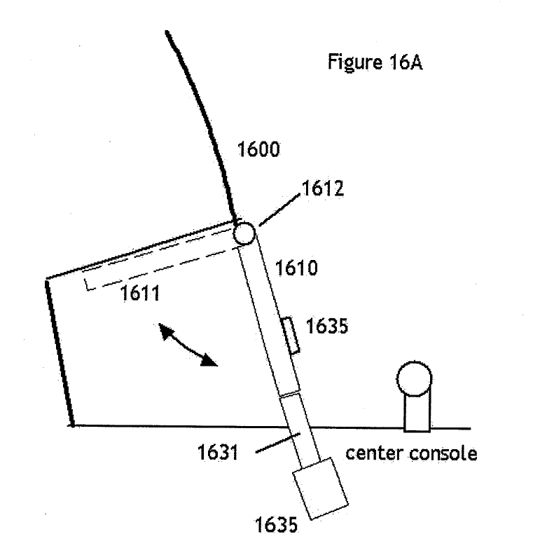

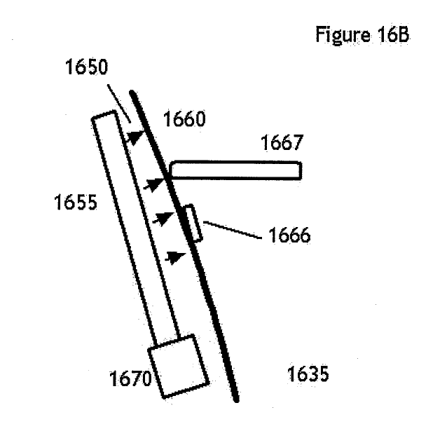

As shown for example in FIG. 16b of my Multifunctional Controls co pending application it is useful to maximize brightness one may in certain cases preferentially increase light intensity of labels important to the drivers perception of the controls, while decreasing the intensity of other projected information, patterns and designs in order to keep the light sources (typically diode lasers or LED's) within their safe duty cycle. With scanning laser projectors this can be done by causing the scan beam to dwell longer on the control labels (e.g., the word TEMP in the center of a knob being used to control heater temperature) and shorter on the non-essential information, which could be even decorative in nature. Alternatively or in addition to changing the dwell time, one can briefly overdrive the light source when writing the labels (for example with a momentary high current), making up for this increase if needed by under driving the source when not on a label. This has the advantage of being able to use constant scanning velocities of the mirrors or other optics used to sweep the beam.

Additionally, or alternatively, it is also possible to use one laser (or even an extra laser), for example a red laser which is widely available in high power levels, which has considerably more power than needed to cooperate with the green and blue lasers for the RGB color generation. This laser would be gunned up in power when needed to illuminate labels, shifting the color of the labels toward or to, that laser color. Green would perhaps be best due to the eyes higher sensitivity, assuming green laser prices are acceptable, which they are not today.

It is also possible to change the size of the label, either the size of the letters, or their thickness or both, in order to improve visibility. This also applies to those persons having difficulty focusing on the screen when the labels are smaller. To facilitate a major change in size, it can be desirable to abbreviate the label, possibly with a pictograph if such is clearly understood.

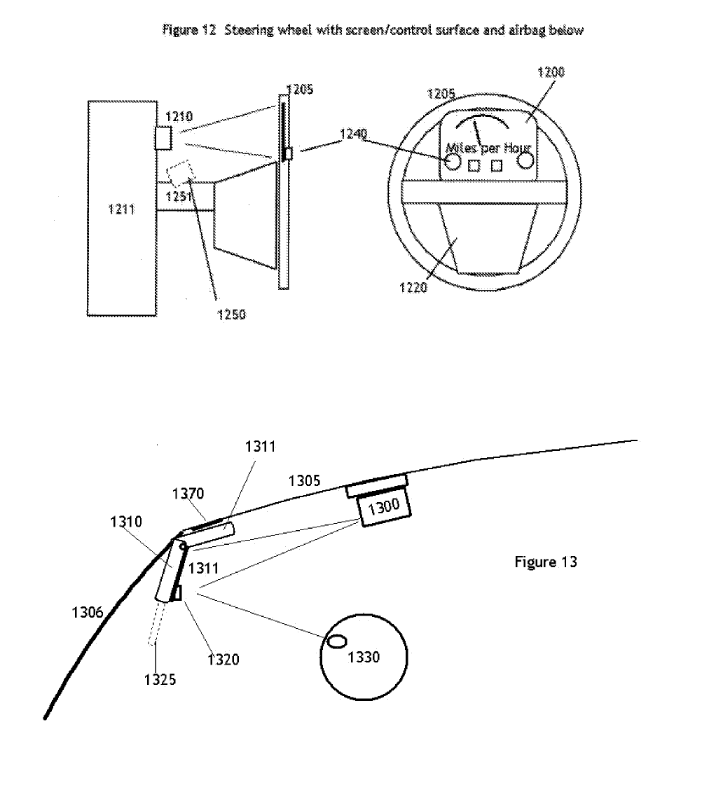

FIG. 12 illustrates an embodiment with screen/control surface 1200 in the steering wheel of a vehicle 1205 with the projector/sensor module 1210 in the instrument panel 1211 ahead of the wheel. This arrangement still allows use of an airbag 1220 below the screen and control surface, with little or no change from present airbag in steering wheel designs. Projection is fixed, even though the screen/control surface rotates with the wheel. (or it could even remain fixed if it was just behind the wheel and anchored to the steering column rather than the wheel). As the angle of wheel rotation increases, this can be sensed by the projector sensor unit and image projection can be reduced in size and altered in shape where desired to fit on the screen that is in view. It should also be noted that the sensing of control position (such as that of knob 1201) and finger touch position, needs to be invariant to wheel rotation if one wishes to have these functions operate with a turned wheel. In this case, the reference points for the controls can be taken from a reference such as mark 1240 on the control surface 1200, which is tracked with wheel rotation and can be used to provide same for use in compensation of sensing and projection.

It should be noted that the screen/control surface 1200 in the wheel as here disclosed, may block any instrument cluster on the Instrument panel (when it is planned to be located in front of the driver). For this reason, the projector may optionally provide information commonly provided in the cluster, such as speed, RPM, fuel gage, odometer and the like.

As an alternative to the instrument panel location, the projector/sensor module (1250, dotted lines) can be located in the steering column 1251. It should be noted that the screen/control surface 1200 does not need to cover the whole wheel radius from center to the periphery, and if the screen and control surface is located just near the center, it is also possible to see conventional instruments located on the instrument panel. Naturally one application of the invention however is to replace these with projected instruments on screen 1200, as well as to provide other useful information such as night vision images, and allow reconfigurable controls to be used by the driver in the steering wheel.

The projector/sensor unit in this case may be for example located in the instrument panel directly in front of the screen on the wheel, or in the steering column. To accommodate the airbag used in the wheel, the screen can be above the airbag as shown, or the technique of a co pending application used wherein at least a portion of the screen is in front of the airbag, with the projection coming in from an angle such that the projector/sensor unit is out of the way of the airbag. In this case the airbag blows through the screen and control surface upon detonation.

FIG. 13 illustrates a front projected sun visor based embodiment of the invention, wherein the projector/sensor unit 1300 (connected to a computer unit not shown) is roof mounted to vehicle roof 1305. A sun visor in its stored state 1311 when not used for image presentation, control, or sun blocking purposes, is swung over into position 1310 and used for display and control. When desired for blocking sunlight fully coming through windshield 1306, a slidable portion 1325 of the visor is pulled down from within the visor to increase its vertical height in the downward direction.

Light from the projector is projected and reflects from the surface of visor 1310 facing the driver 1330. The angle of the visor when swung down from the rest position, is fairly constant, such that with suitable design of the reflective elements of the screen 311 on the back of the visor the projection can be preferentially reflected with high gain back to the region of the drivers eyes. The projector may not be directly over the driver's head, but displaced toward the center of the vehicle so as not to be in the way.

As shown, the device has several purposes and features. First, it should be noted that the visor in a typical vehicle when pushed past the vertical toward the windshield, is quite visible to the driver, without blocking too much of his forward vision. This means that it may be desirably be used for both image display and control purposes using the invention.

In the first case it may be operated in an image generation mode, for example, where an image of for example a night vision image is presented, as an alternative to having such presentation in a heads up display on the windshield, or in an instrument cluster. However, the advantage of this visor location is that the visor is accessible by hand by the driver which also means it can be used for reconfigurable control purposes. This is not easily and intuitively possible with either HUDS or conventional instrument clusters behind the wheel.

Note that one can locate a screen and control surface using either front or rear projection, in the portion of the roof 1370 in front of which the visor in its parked state 1311 resides. In this case, one just need swing the visor away from the zone 1370 in order to use the controls there.

Note that one may also arrange the system such that the sun visor, in its stored location 1311, may also be used by the driver for viewing of displayed information thereon as well as for control of vehicle functions using the invention. This has the advantage that the reflective bead or other screen material is on the back of the visor when rotated down, leaving the present vanity mirror as it is now. However the angle of the visor in this stored location is typically parallel to the roof at that location and thus very oblique to the driver and to a roof-mounted projector. This can be helped a bit by making the hinge locations stick out from the roof about an inch or so, allowing the front of the visor to be a bit downward from the roof. And it can be helped by spacing the projector away from the roof, which is easier to do if the projector is toward the center of the vehicle where it does not occupy headroom of the persons in the left and right seats.

When the knob or other control is on the part of the visor facing the driver when swung down, it is useful to provide a recess in the roof headliner for the knob to fit into.

An interesting aspect of the invention in its ability to optimize light energy from the projector/sensor unit seen by the driver or another selected recipient.

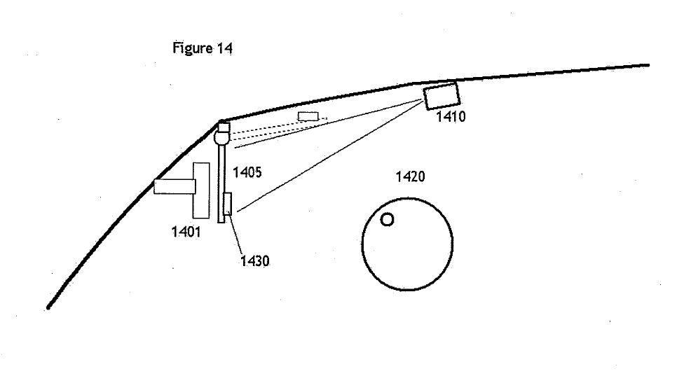

FIG. 14 illustrates an embodiment of the invention in which a screen/control surface 1405 may be temporarily pulled down in front of the inside center mounted rear view minor 1401 of a vehicle, in order to act as a control device, or a image display (for example of video data taken of, or from, a trailer one is pulling). In this example a roof mounted projector sensor unit 1410 illuminates the surface 1405 via front projection, but a rear projection arrangement may also be employed. In either case high gain is possible as the drivers location is relatively fixed, other than the variance in size of drivers. A control device such as knob 1430 is shown.

In those embodiments in which the display is for use by the driver, and is in the sun visor or steering wheel, or in front of the minor, I feel that these may become viable for control, generally only if there are physical, intuitive and familiar controls such as knobs sliders and switches on the screen/control surface. A pure touch screen type function, while interesting and flexible, lacks traditional feel and understanding. Thus physical control configurations disclosed herein will make systems in unusual places like the visor or steering wheel viable. If it isn't totally intuitive, it may be dangerous.

FIG. 15 illustrates an embodiment of the invention in which the projector/sensor unit 1500 and other components such as minor 1510 if used are arranged to mount in a “Double Din” sized audio slot 1520 in a car, with an expanded screen and control surface 1530 made possible by the divergence from the projector/sensor unit when 1530 is located a distance “D” away from the front face of the slot-ed surface 1540. It is also possible to provide decorative or personalized info on side of the display. Can project images to blend with decor. Etc.

Also illustrated is an Optional slide up LCD panel 1550 which may be provided to increase size of the display when pulled up in the position shown. Can mesh images to provide a unitary image as has been discussed in co pending applications.

In this case the LCD display, when in the down position, blocks some of the projected information. However, while more complex, one can alternatively have an LCD display that comes out horizontally and springs up.

Since the unit of FIG. 15 (and other previously described embodiments as well) can reconfigurably function as both an Audio system and a HVAC system, it can replace both. In this case, one can have storage or other functions below the unit which would normally be used for the HVAC (heating, ventilation and air conditioning) controls.

At this writing I believe that this “double din” arrangement will find most value in the aftermarket, allowing larger screens by letting the projection of images spread out of the fixed standard double din slot in existing cars to a screen positioned a distance ahead of slot to provide a larger screen—and control surface too, which has the added advantages of allowing the image to go to the edge since the controls are on the screen itself.

FIG. 16A illustrates an alternative embodiment in the center stack 1600 of the vehicle in which a fold up screen 1610 of a “wedge” wave guide type (see “Wedge-shaped screens for flat panel projection display” by A Travis, F Payne, J Zhong, J Moore, Cambridge University, Cambridge CB2 1PZ, UK) is employed which folds down from a stored position 1611 via hinge 1612. The projector/sensor unit 1630 is located below the center stack, and light from/to the projector/sensor unit is expanded by expansion portion 1631. Knob 1635 is located on the surface of the screen 1610. The region 1636 provides a convenient storage area when the screen/control surface 1610 is folded up into a park position.

In this case illustrated in FIG. 16B, the arrangement is a bit different than discussed by Travis et al, in that projection of radiation 1650 from the wedge plate and expander 1655 (and in reverse, for the knob 1666 and touch data from finger 1667 thru to the sensor portion of the sensor/projector unit 1670 passes thru air to a curved screen 1660, which may employ for example 3M Vikuiti diffusing material 1665.

It can be appreciated that such a wedge type design can be located in other locations in the car or elsewhere. For example the screen and control surface can be in the back of a seat headrest, with the wedge expander as well as the projector/sensor unit, located in the seat back.

FIG. 17 illustrates an embodiment of the invention which makes use of the unique ability of the invention to have an easy to clean and even sterilize-able screen and control surface 1720, in this case for use in a hospital bed 1700, with the projector & sensor module 1705 located in the foot of the bed, or alternatively in other locations such as the side of the bed. The same approach can be used in beds in general, such as in a home or hotel. The Screen/control surface can be attached to the bed or freely held as described herein. Can be pulled out, or folded out from side of bed. The person can not only see a TV program displayed on the screen, he can control the program with knobs 1725 and other physical controls or touch functions. And he may use the device for selecting meals for the day, interacting with patient databases, sending emails, contacting the nurse's station, controlling lights and so forth.

It is important to note that in this example the Screen/control surface is inexpensive, is largely unbreakable, and has no wires or other problem items. The projector/sensor unit is out of the way and doesn't need to be moved. All electrical connections are between the projector and computer/Display/speakers, without causing a shock hazard or other problem for the patient handling the Screen/control surface. This surface indeed has many advantages in this application. It is easy to move out of the way. It is light, thin, no wires, and simple plastic screen/control surface and thus is good for hospital beds, wheel chairs, and chairs in nursing homes or family rooms, and other applications. It is also removable and easy to store. The screen/control surface in some cases can be of flexible plastic and rolled up if such is desired.

It is noted that in this hospital bed application, or alternatively in a vehicle, or easy chair in ones home, or other location, the screen and control surface may be freely held with respect to the projector/sensor module using the ability of the system to realign its projection and sensing coordinates based on determination of the location of fixed datum's on the screen and control surface 1720. The datum targets 1730, 1731 and generally others on the other two corners of 1720 allow the sensor unit in 1705 to determine the location of the 1720 and adjust the projection and sensing image data positions accordingly, when the surface 1720 is within a desired operating range. This is a dynamic function, which allows the person to move the screen and still get accurate projection and sensing within a certain accommodation range.

This capability also allows the system to sense using IR in an unobtrusive manner, and only turn the on the projector when the screen and control surface is in the accommodation range in both xyz and angular position All 6 degrees of freedom of 1720 with respect to 1705 can be solve using data from the 4 datum's in known position on the screen and control surface in place.

The material of the screen and control surface can be constructed of material that can be sterilized, either by heat or by radiation. This is a major advantage of the invention.

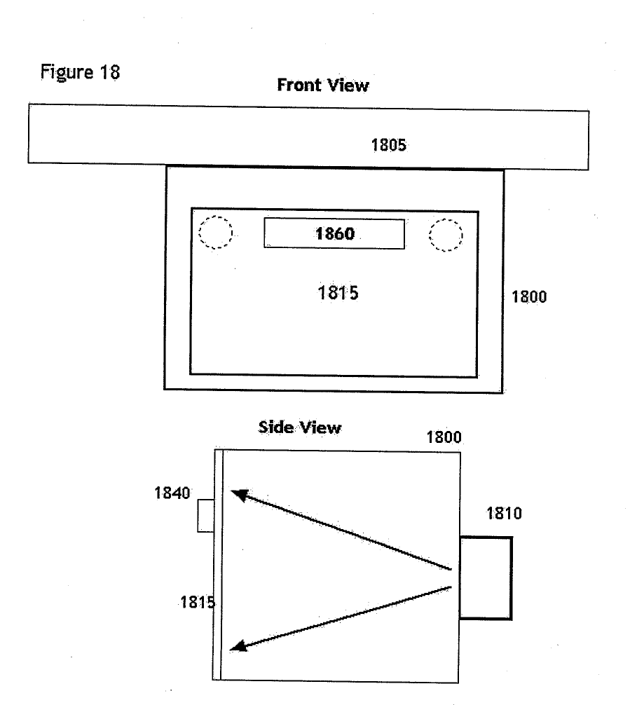

The invention can further provide an oven with a unique capability. Such an oven can have a window, which allows presentation of TV entertainment and acts as a device for reconfigurable control functions, as well as a window for looking at the object being cooked, if desired. FIG. 18 illustrates a microwave oven 1800 of the invention, which is mounted to the base of a cabinet 1805 in the kitchen, but has a major advantage over existing ovens of this type. Namely, the projector 1810 of the invention allows projection of TV entertainment on the diffusive conductive screen 1815 in the door of the oven. The door in this case (not needed in a conventional oven) is provided with transparent conductors, or fine wire conductors, capable of shielding the microwave radiation from the room, while at the same time the door is provided with diffusive surface or material capable of diffusing the light from projector 1810. In addition by optionally incorporating a sensing capability, the oven can further include the controls, such as knob 1840 or touch functions on the face of the door 1815. This results in a more compact device.

Ideally the diffusive surface should not be so diffusive as to prevent viewing of objects being cooked, when in a cooking mode. Or alternatively another screen can be substituted when viewing is required. Or as another alternative, a portion of the screen, such as portion 1860 can be transparent while the rest is diffusive.

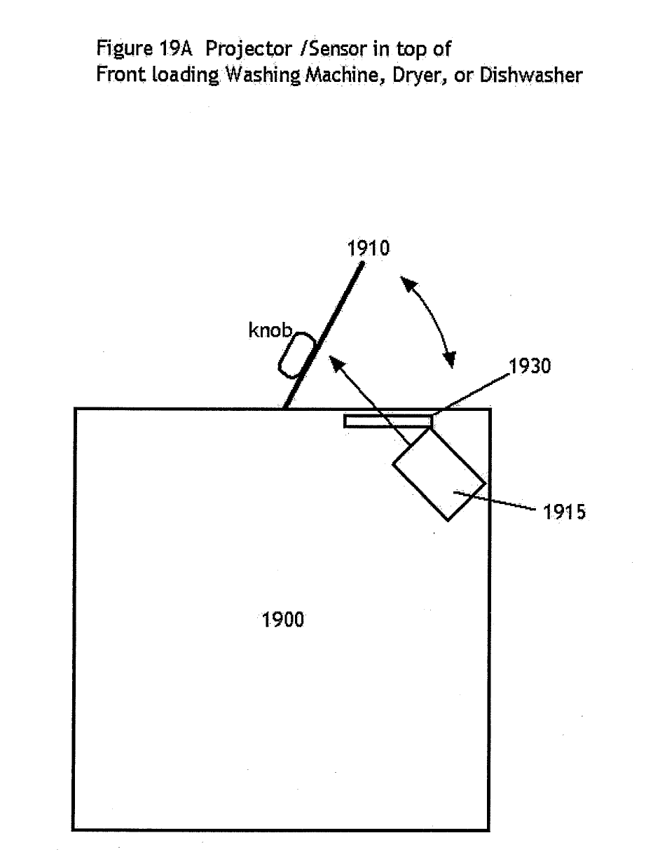

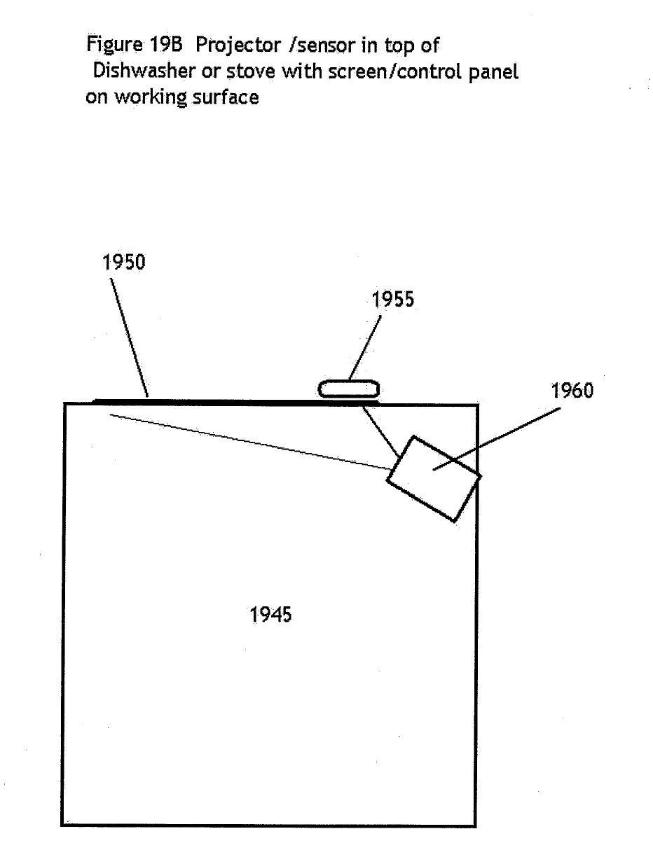

FIG. 19a illustrates an embodiment of the invention useful for appliances in general, as well as desktops and other applications. In appliance flips up when controls needed and also acts as a entertainment TV for person using the machine. When tilt up projector comes on, a feature also useful in the car application above and other applications.

Another version shown in FIG. 19b has the screen/control surface forming at least a part of the actual work surface on the top of a freestanding dishwasher. The surface can serve as a cutting board, a TV for entertainment in the kitchen, as well as a control panel for the machine, and perhaps other appliances that might be wirelessly or otherwise connected to it. The screen/control surface as described above can be removed for easy cleaning, which is of use in food preparation. Recipes, photos of various meals, and other such things can be displayed on the screen too. The same arrangement can be in a stovetop, as the controls and screen can be of high heat resistance material such as Pyrex for example, and the projector/sensor module located remotely in the rear in a well ventilated or otherwise lower heat location. In extreme cases, projector/sensor modules of the invention can be thermoelectrically cooled as well. This would perhaps be the case when employed in the dashboards of Army vehicles in desert conditions for example.

It is important to note the cost advantage inherent in this system. Assuming one wants TV nearby for entertainment while doing chores, the Extra cost of the TV portion is cost shared with the controls in this application.

The projector can be located as well in the back of a front loading dishwasher or washing machine, and used to project on the front thereof during periods when not washing. A pull up screen and control surface can be used in appliances similar to the center stack version of FIG. 4A, as can swing in and other arrangements.

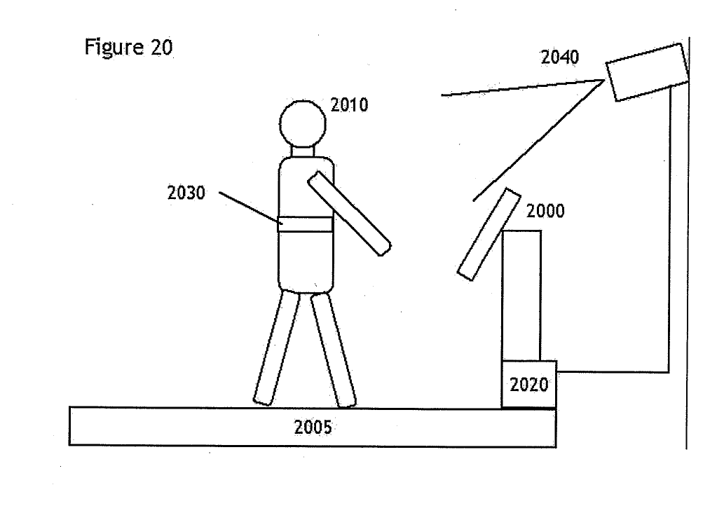

FIG. 20 illustrates an embodiment of the invention in an exercise machine, such as a treadmill, stationary bicycle, rowing machine or other machine, and further illustrates combination with other technologies for determining position or motion of members and pulse information.

The screen and control surface 2000, on treadmill 2005, is used by the user 2010 to control the machine and workout, as well as to view TV programs, which may be also downloaded from an MPEG or other such device carried by the user if desired. Computer unit 2020 takes in data from the machine, and optionally from the wireless pulse transmitting belt 2030 on the user, as well as TV camera data obtained concerning the users positions or motions by camera 2040. Wireless means for this or other embodiments of the invention can be IR, Bluetooth, WiFi or any applicable type.

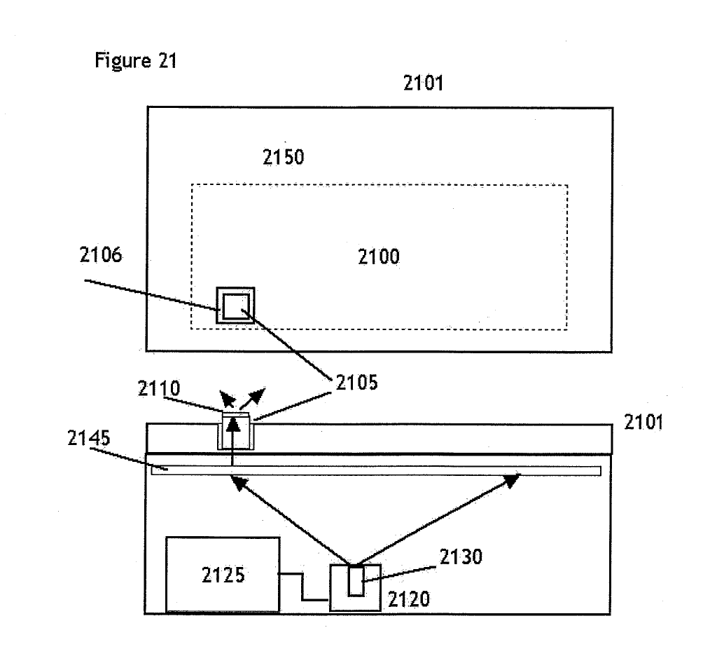

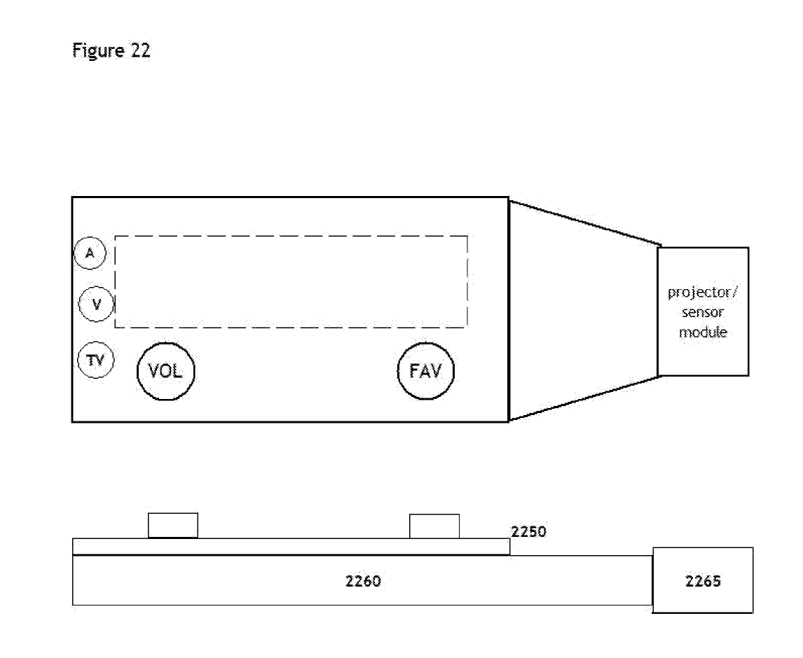

FIG. 21 illustrates a portable embodiment of the invention for use as a keyboard 2100, employing in this case keys such as 2105 (only this one key shown for clarity) which have a diffusing face 2110 such that with suitable projection by projector 2120 onto the face from the rear that they can change their labels under control of computer 2125. These keys can slide up and down in a plastic sleeve 2106 of square cross section as in a conventional keyboard, and can even make use of conventional means to determine they have been pressed. Or the state of pressed can be determined electro-optically, as in many of my co pending cases. For example using TV camera 2130 whose image is processed by computer 2125 in order to determine reflection changes from a point in the camera field corresponding to a key location due to the key at that location being pressed. Alternatively to a TV camera, a combined sensor/projector can be used, as disclosed elsewhere herein. Where keys slide a significant distance it can be desirable to use Fresnel lens 2145 to substantially collimate light from the projector. Where a flat keyboard is desired, a “wedge” wave guide like design such as described by Travis et al in the SID June 2006 proceedings can be used for both sensing and projection, as shown in FIG. 22 below. If the projector/sensor module is off to the side, an off-axis Fresnel lens can be used.

Besides key information such as the letter of the key (e.g. “A”), the screen and control surface 2101 (of which the keyboard is a part) can have other projected image information in regions of its surface as desired, such as region 2150. This can be graphics, function keys etc. And given the invention herein these regions can operate as a touch screen. Indeed the keys themselves can operate this way, but the tactile feel is not what people are accustomed to. Keys alternatively can be comprised of deflecting membranes, which do have some tactile feel.

FIG. 22 illustrates another portable embodiment used as a remote control for a Video/audio system in a home (and optionally providing a degree of video and audio capability itself via its display and optional speakers).

This can be operated in a pure touch screen mode, but desirably for many people has some degree of conventional controls, such as reconfigurable volume knob shown, which also can act as a channel selector to go to ones favorite channels. Note that the remote itself has a screen that then acts as monitor to check out other station selections, rather than have the picture in picture approach, which can disturb others. One can also have insert-able portions comprising alternative screen/control surfaces such as a keyboard shown in dotted lines. This insert can be snapped to the back of the device and used as needed, or slid into place for example.

As shown there are two knobs, which when in normal TV watching mode represent the controls used most often such as a Volume knob, and a Channel knob to turn thru ones favorite channels—usually a set of say 10, but programmable of course. The beauty of the knob for this, like the knob of channel selectors of TVs long ago is that you can see it and turn to it immediately. The channel markings can be projected right on the screen next to the knob, or in the center of the knob.

Then when one wants an audio system, you press the hot button for that (labeled audio) and the Channel knob turns into a selector for play lists displayed on the screen. Possibly other functions would be needed, which can be provided as disclosed in other applications. And the same holds true for stored video files, accessed by pressing the V button shown. A pair of built in speakers (not shown for clarity) can make the entertainment coming from this portable control device complete.

Many believe that the remote control unit in a hospital room is the dirtiest thing there is in the room. One approach to solve this problem has been shown in FIG. 17 that allows the whole control interface to be sterilized or otherwise cleaned. Another, is shown here, where the touch screen and control surface 2250 may be a separate member from the screen member 2260 illuminated by sensor/projector 2265 (and associated computer not shown, together with any wireless transmission devices such as IR, Bluetooth or the like) and this user interface member 2250 can be easily removed and washed along with the control details if used.

In a similar vein a device like that of FIG. 22 can be used as a Nurses notebook where she can document patient issues, and use the ability of the computer to call up images on the screen etc. Like many other applications of the invention this is usable in a high stress environment where menu based devices such as PDA's or Tablet PCs are hard to operate (and hard to clean).

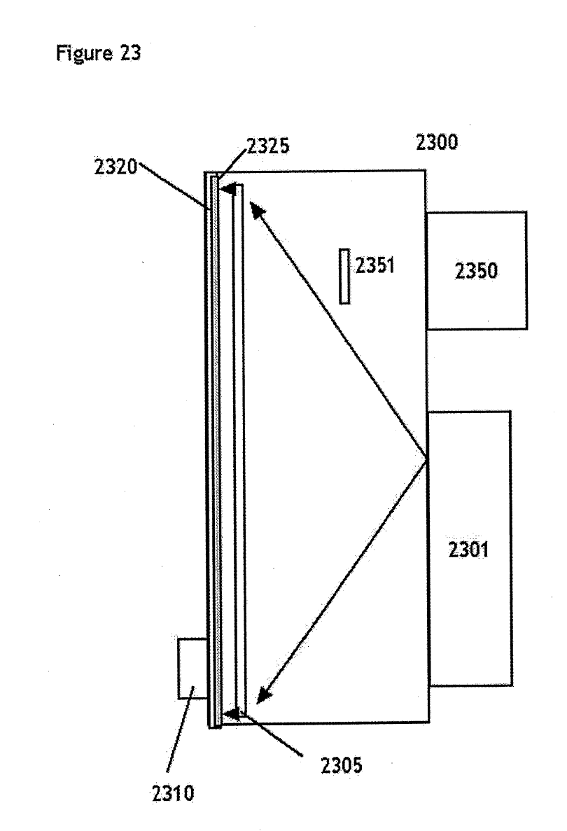

FIG. 23 illustrates a digital camera 2300 having lens 2350 and CCD array 2351 to obtain the desired photograph. The very large image viewing surface 2320 is made possible by the advent of very small projectors from MicroVision Corporation and Symbol Technologies, which can be equipped with sensing capability of the invention to form a projector/sensor module 2301 and associated computer which in this case projects through Fresnel lens 2305 onto the screen and control surface 2320 having 3M Victim black beaded rear projection film 2325 on its back face (toward the projector) which provides very good contrast in sunny environments, answering a problem with today's LCD equipped digital cameras which makes many inoperable if one relies on the screen image. The invention also has an advantage in this application over today's cameras, in that the largest possible screen area is provided, with familiar and tactile conventional control details such as knob 2310 on the screen/control surface 2320. These conventional controls are easy to operate without looking and in a hurry, a big advantage for a camera. And they can be reconfigured to allow a minimum of controls to be used, preserving the maximum display space. Less used controls may be accommodated by the touch screen function of the invention on surface 2320.

It should be noted that the machine vision processing used in the sensor of this embodiment to see finger touch or control position, may also be used in some cases to process data from the CCD or other camera chip itself. This may be done, if desired, along the lines of my co pending US Application entitled Picture Taking Method and application, also published as U.S. Pat. No. 7,015,950.

A high gain screen (or screen segments in the case of individual keys) can be used if desired with hand held devices of the invention, as the person using the device is generally looking at the screen from a known angle (typically looking more or less normal to the surface in the case of a camera or remote being viewed, or at an angle dictated by hand positions in the case of the keyboard). Some applications like digital cameras however have a secondary use for showing friends ones pictures, which argues for a more diffuse, lower gain screen.

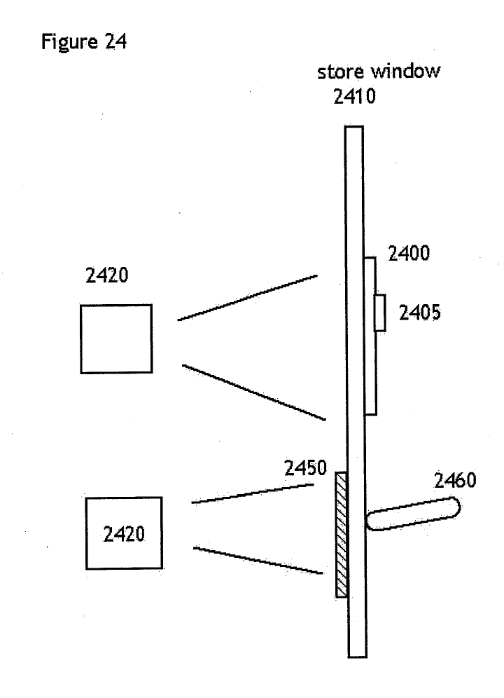

FIG. 24 illustrates a store window embodiment of the invention allowing passers by to interact with a computer system inside the store. This embodiment is useful for environments that are separated, in this case to provide a window display, which allows passers by on the outside said window to control projected information from inside said window using either finger touch or physical controls sensed from inside.

It is noted that the ability to separate the projector/sensor module from the screen/control surface allows one to interpose windows or other optical elements in-between. For example, the screen/control surface, 2400 including touch functions or physical controls such as knob 2405, or both, may be located on the pedestrian side of a store window, 2410, and the projector/sensor module of the invention 2420 on the inside, providing rear projection of information to the screen/control surface, and sensing persons input. This allows passers by to interact, using familiar controls such as knobs, sliders and switches, touch functions or both, without having any complicated equipment on the street side that might be damaged or otherwise made inoperable. If damaged, the screen and control surface can be easily replaced. Or it may be interchanged with another, perhaps set up for a different purpose, with different controls in different locations.

It is also noted that the diffusive screen material such as 3M Vikuiti such as 2450 may alternatively be provided on the back of the store window in side the store, in which case finger touch of passers by, such as with finger 2460 in response to projected information may be sensed without anything at all on the outside of the store window. This has major advantages for maintenance purposes.

The interaction of passers by can be relative to projected textural or graphic data on the screen and control surface, audio information concerning products in the store, or with other computer controlled systems, for example to turn Christmas tree lights on in a window display.

The use of front projection for control purposes as well as display as disclosed in FIGS. 2, 13 and elsewhere herein, is quite useful. However, when using this mode of the invention there are potential problems with ones hand obscuring the controls being worked, and as well obscuring the projection of information concerning the control. For example, if one touches a projected touch icon, (e.g., the word TEMP, projected in a box on the screen) one needs to sense the finger touching this icon, in order to act on it. This can be done by noting the difference in reflectivity of the screen back to the sensor when the icon is not touched, versus when it is touched. At this time other icons which might be displayed would be in their not touched condition—as long as in touching one, the others are not obscured.

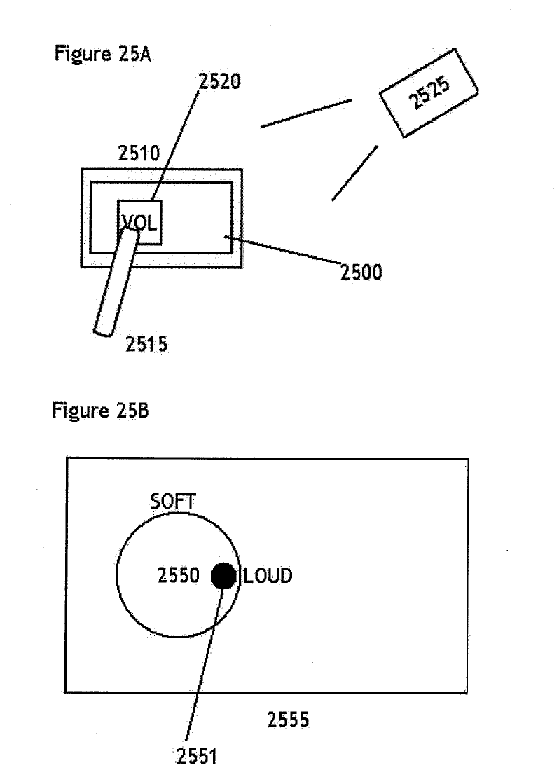

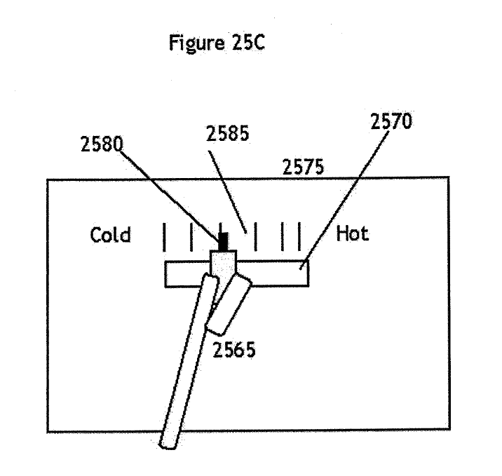

For example, note the situation in FIG. 25A. A somewhat directionally reflective front projection screen 2500 is provided on the back of headrest 2510 on the front seat of a car. A user reaches up to touch with his finger 2515 a VOL (for audio system volume) icon box 2520 projected by projector/sensor module 2525. Prior to his touch, the sensing contained within 2525 has received a strong signal back from screen 2500 at all points, since 2525 and the user are both within a high gain region of the screen. When the user puts his finger however on the touch icon box projected, the signal in that area drops substantially as the persons finger is not as reflective, and thus the fact he has touched this icon box (and not another for example) can be recognized easily by the computer contained within the projector sensor module. If required for assurance of touch, In addition the shape of the finger and its color if desired can be recognized as well. These indications are almost always sufficient to tell if the person touched the screen at a given location.

When the person's finger approaches the screen, some projected graphic or textural information will generally hit the person's finger. This is not necessarily disconcerting, but if desired, one can sense this too, and cause the projection in the region of the finger to be stopped.

Where physical controls such as knobs, sliders or switches or some other controls are used in front projection applications, the situation is a bit different. There are two points. First, such a system can be operated to register the position of a turned knob for example, after the person has let off the control. In which case there is no obscuration at all. This is illustrated in FIG. 25B where the person has turned the knob 2550 on screen and control surface 2555 to a new position, and datum 2551 on the knob, which previously was at 12 O'clock position, and is now at 3 O'clock, is sensed by the sensor in the projector/sensor module (not shown). The graduations on the knob are projected, and the user has turned the knob to a new graduation. This could be a line, or to a number, or to a graphic, or to a word, such as “Loud” shown.

Secondly, in designing the particular system in question, the control can be made to show a recognizable datum to the sensor of the projector/sensor module even when ones hand is grasping it. This generally may be accomplished when the size of the control is relatively large.

For example consider the use for temperature control purposes of slider 2560 in FIG. 25C which is moved by the fingers 2565 of a user along a slide way 2570 in front projection screen and control surface 2575. As the user operates it in normal fashion, a portion of the slider handle 2580 is visible to the projector/sensor module (not shown for clarity) which can determine its location relative to projected information such as the words Hot and Cold, the graduations 2585, or to the screen and control surface itself.

This technique while very useful, however doesn't work well for push switches, which spring back to their original position when let off, unless they are visible to the projector/sensor unit during the push. It does work for those push or slide switches which stay in position when actuated.

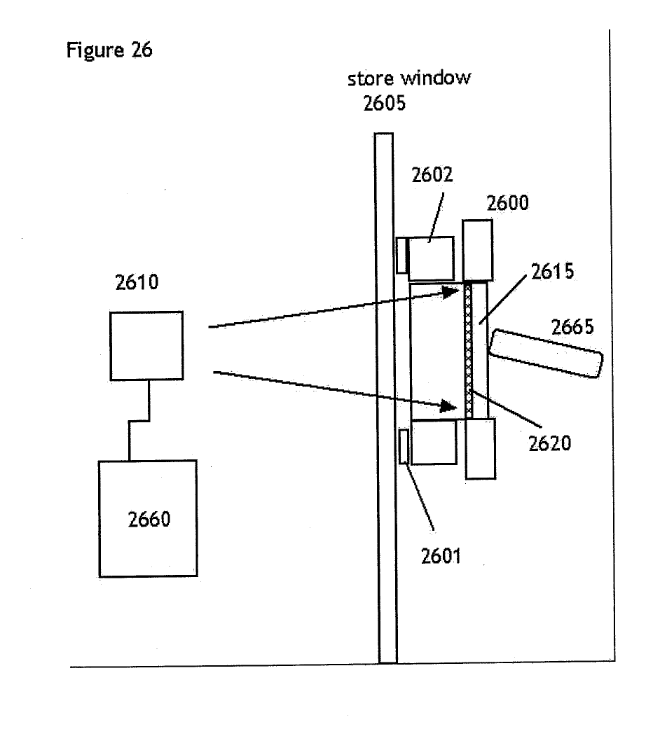

Another variation of the separated components theme of FIG. 24 is shown in FIG. 26, in which a large knob 2600, in this case potentially say 8 inches in diameter is attached on its raceway 2602 by adhesive 2601 (or other means as appropriate, including magnetic means) to store window 2605. Projector/sensor module 2610 projects images onto the center of the knob, which has member 2615 diffusive material 2620 such as 3M Vikuiti located in its center. Alternatively the diffusive surface may be on the inside of the window as shown in dotted lines 2625.

As the user turns the knob, important information concerning the displayed items or the store or other aspects is projected. The user can interact with the computer 2660 connected to the projector/sensor 2610 (and any other store information or displays) in two ways—by turning the knob to a given location, or touching projected icons or other information in the center of the knob, for example using finger 2665. Where this touch aspect is desired, it is best to have the member with diffusive material on its rear surface on the outside, like 2615.

The knob so to speak can be supplemented by other controls, such as sliders, switches or knobs that can provide further interaction capabilities for the passers by. The knob too can be large, more like a steering wheel of a car, or a ships wheel, if desired. This gives more display space and provides a unique appearance.

While in this FIG. 26 example, all displayed information is shown in the knob center (which also limits the area necessary to illuminate and saves power), it is also possible to have diffusive material around the knob such as shown in FIG. 24, allowing interaction with labels and other graphics and such which might be there displayed.

It is also noted that the knob (or other physical control detail used) can be very inexpensive, and would not constitute a big loss if stolen or knocked off. All the key components are inside the store.

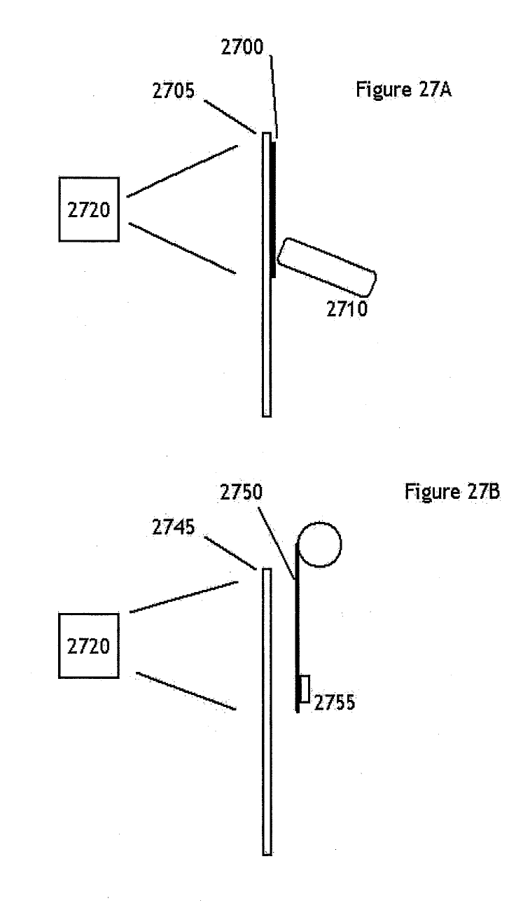

FIG. 27A illustrates another embodiment in a car window. As shown in FIG. 27A, one can have a diffusive screen 2700 located on a car window 2705 which could be just a sandblasted section of the car window itself, preferably on the inside as shown for best touch results. When the driver touches, with his finger 2710, a projected image portion such as an icon projected by projector/sensor module 2720 through the window of the car, the location of his touch is sensed, and appropriate action made. This could be, in a drive through restaurant line, the ordering of a “Big Mac”. As shown above, added controls such as knobs can be provided on the window as well. The projector sensor unit of this type also could be valuable in toll booths, drive in banks and other places where the “hardware” is fixed and maintainable, but the user is only temporarily in an information interaction location.

FIG. 27B illustrates a second version in a car, in which a pull down “window shade” of flexibly rolled up diffusive material 2750 behind car window 2745 is used for the screen and control surface; in this case also containing a knob 2755. While flexible, vibration and other effects caused thereby are not a problem to machine vision based sensing as I have disclosed.

It is also possible to pull down a rigid or semi-rigid screen containing diffusing material useful for a screen, including knobs and sliders etc, from within the sun visor in a manner similar to shade 1325 pulled out of visor 1306. The visor, as today may be pulled down in front of the windshield to accommodate a projector sensor overhead, or swung over to the side, to allow operation in a manner of the FIG. 27 drive through lane.

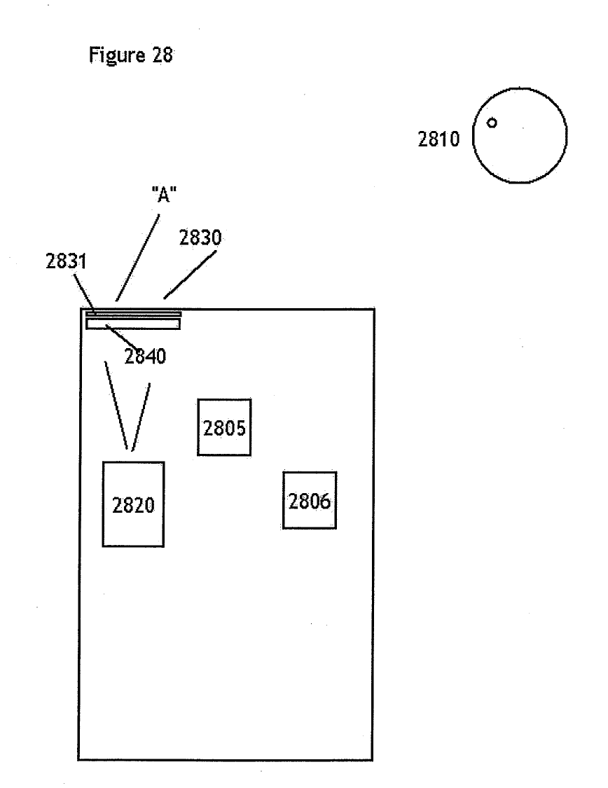

It can also be appreciated, that the invention can be applied to glass showcases in jewelry stores and the like. FIG. 28 illustrates an embodiment in which a clear glass showcase 2801 contains various items such as 2805 and 2806 on display, viewed by customer 2810. A sensor/projector unit of the invention 2820 projects on a diffusing screen/control surface 2830 comprising the top of the display case in this case with diffusing surface underneath 2831 in this case shown out of the way of the customers easy vision at the back of the show case. Optional prismatic film elements (e.g. via a 3M brand film) 2840 to preferentially direct light toward the customer's eyes. If the customer is interested in an item in front of him, he touches the glass at Point “A” on the screen and control surface represented by the top of the Glass, (finger not shown for clarity), and information is displayed concerning the item for a period of time, or until he touches another place. It is noted that since he only touches one place at a time, that the light distribution of the visible projection can be concentrated into just that region of the display (in the direction out of the plane of the paper), thus saving energy, and creating little confusion. The operation of the sensing portion however, typically in the near IR so as to not be visible) generally needs to be in all regions out of the plane of the paper for which it is practical to project, as one does not know where the person will touch. Thus every 200 mess one could check for finger touch (using a quick scan say 30 msec long and thus not noticeably interrupting the visual projection in the region of interest, while projecting visual information the rest of the time.

Disclosed previously was an embodiment of the invention serving as a control panel and dashboard for a Combine, Road Grader, or other working machine, including a military machine. In this case, rather than combine the two functions on a single panel, an alternative (for this and other embodiments) may be constructed in which a slid-ably interchangeable control panel is employed to switch function from a vehicular movement, to working machine. The advantage is the directly in front of the operator is all the controls and data he needs for the task at hand. There are other ways of interchanging the panels, such as physically taking one off and putting one on, using a turret arrangement or whatever.

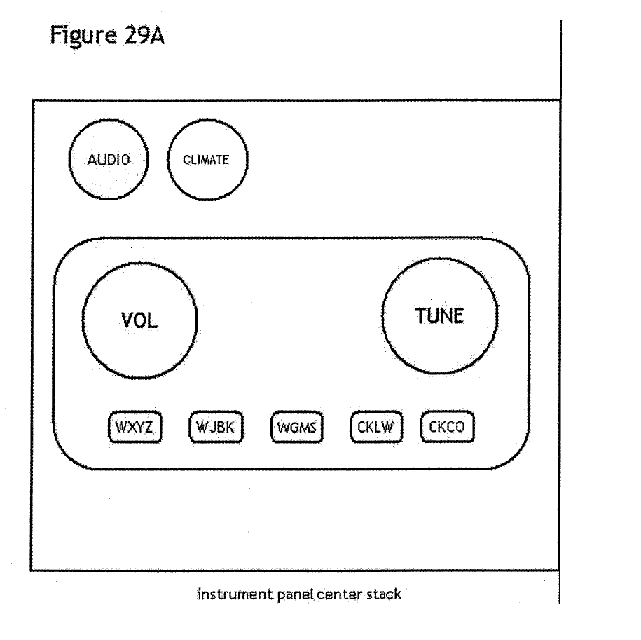

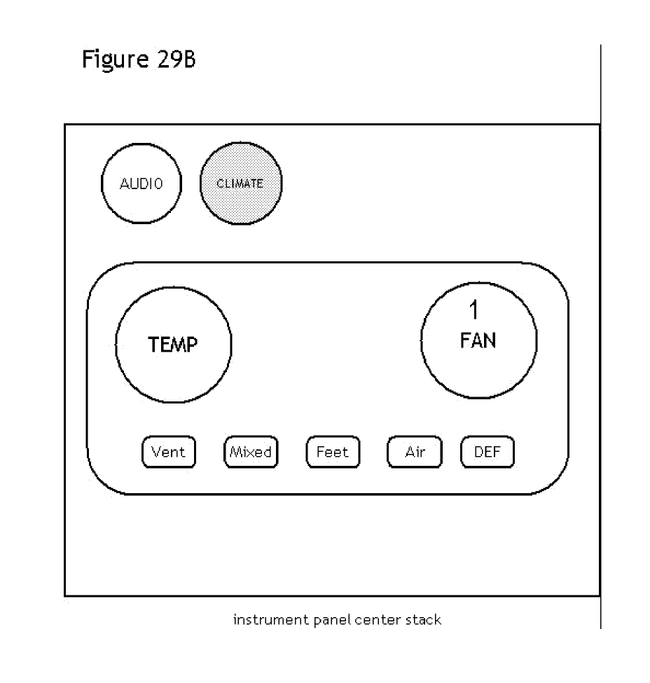

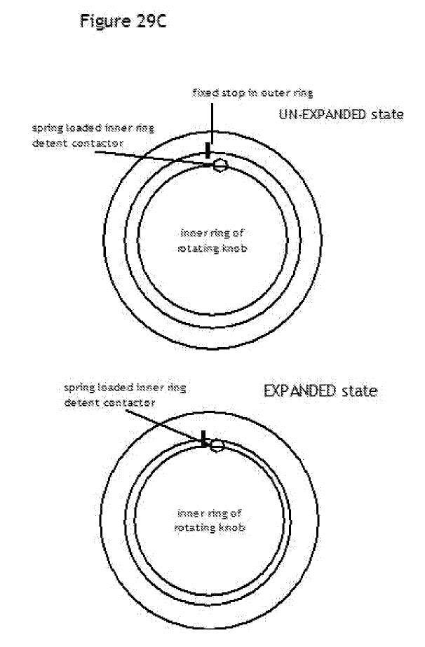

FIG. 29 illustrates a version of the invention for the center stack of the vehicle further in the Radio-Heater metaphor mentioned in my referenced co pending applications. FIG. 29A illustrates the unit in audio system mode, achieved by touching the “Audio” button, which causes the video display to label the controls accordingly. FIG. 29B illustrates the unit in Climate control system mode, achieved by touching the “Climate” button, which serves to change the projected image data, and the control outputs of the control system used. The point I want to make here, is that the user can easily learn the location of the basic physical control details, in this case two knobs 2905 (the Left knob) and 2906 (the Right knob) and 5 switches 2910-2914, since the controls are in the same place for both the Audio and heat functions. The person only need remember which mode he is in, Audio or Climate, and this can be reminded by having the appropriate light 2901 or 2902 lit up, for example. And words such as “AUDIO” also displayed in big letters in the language of his choice on the screen and control surface 2900.

Thus an argument is that this is more intuitive than today's almost universal arrangement of having both Audio and Climate as separate modules, but with absolutely no common features between them. This is even more the case, since to do this occupies space, which means that to squeeze these separated modules into the same space, one has to make the individual controls, and their labels, smaller and more difficult to work and see. For many older drives in fact, it is not possible to safety discern the labels on many such devices while driving.

I believe that what I have invented is a significant improvement over the basic car of today, leading to more enjoyment and less driver distraction. It is now of interest to point out that FIGS. 29 A and B are the most common layouts of my controls which would preserve the traditional layout. Why? Because the audio system has for years had a volume control, a tuning knob, and 5 or so preset buttons for favorite stations. I have just carried this layout over to the Climate control, which the knobs for temperature and fan speed, and buttons for the vent air distribution. These functions are themselves at least somewhat standard too, so the whole arrangement departs little from what people, particularly (but not necessarily) older people, are familiar with—except that each module, is only workable by being in that mode.

In so doing the above, it is interesting to note that both Volume and Temperature are historically analog continuous functions. Thus the same Left knob with no detents or just little closely space “notch” detents can suffice for volume and temperature functions. I have shown this knob purposely on the left as it closest to the driver, as it is my belief that volume in the audio case, and temperature in the climate case, are the most important, or at least most used, functions.

In the case of the Right knob, in the Audio mode, the tuning knob is continuous. In Climate mode, the fan speed can also be continuous using a rheostat, even though most fan units in cars today are operated with a fixed set of speeds (usually 4 or 5). Or the speed is selected automatically in some cars with “automatic climate control”. In the Right knob case, if one wants to have it like today, then one can have a continuous knob when in Audio mode, with a program-ably actuated detent when in climate mode. I have disclosed such a device in copending applications, but will further point out a simple version below in FIG. 29C.

The switches 2910-2914 operate tactilely the same for both presets and air distribution. Push one in (or slide it, if that type used) and the station changes to that station, or the air comes out that vent set.

One can have all manner of optional control functions with my invention, achieved with touch screen type functions, or added physical controls or a combination of the two. For example, touching a touch icon could make the preset buttons correspond to a different set of stations, perhaps on a different band (e.g., FM vs. AM). The important thing though, is that the basic functions are standard and easily committed to memory and easily found and controlled while driving. This is a major advance re Driver Distraction. Also important is that when desired, the Audio and climate functions may themselves be replaced by something else, such as a play list or a big image of a map or a rear camera picture for example.

It should be noted that pictographs or abbreviations can be substituted for words, if desired or for size reasons. However the ability of the invention to change the language of the label makes hard to understand pictographs less necessary.

Previous disclosures incorporated by reference, for example Ser. No. 11/319,807 in FIG. 16, have illustrated a simple detent mechanism that could be used for the right knob above. When Climate mode is turned on, a member is actuated by electromagnetic or piezoelectric or other known means to ride on the outer diameter of an inner ring of the knob as the knob is turned by the user, the actuated lever contacts the detents (e.g. 5) on the ring representing the 5 speeds of the knob. The momentarily hesitation resulting signals the person turning the knob accordingly, as he for example ramps up speed 1-2-3-4-5. In this case the speed “1” is projected into the middle of the knob, though it could be around it, and laid out conventionally like a clock.

This Right knob in this case however has one difference. Rather than go to a fixed location where it can go no further, which takes added electromechanical complexity, this knob can be turned further, in which case the speed sequence starts over, or if desired, goes back the other way. For example 5-4-3-2-1. One company, Immersion corporation, builds knobs with much more versatile detent combinations than 1 have just disclosed, however, they to my knowledge do not have one that leaves the center of the knob clear for projected information as this does, nor one as low cost. It is however possible to use one or more immersion knobs with my invention, if labels are projected next to, rather than in the middle of, the knob.

Alternatively, FIG. 29C illustrates an alternative knob with a clear center that duplicates today's fan speed operation knobs. It has a programmably actuated outer ring providing detent pockets and a fixed stop when actuated. The stops can be provided at both ends, rather than just one as shown, in order that operation be similar to a discreet fan speed knob in common use today.

Referring now to other embodiments, one may also provide a flip up and over tray table like version in an airplane seat behind a bulkhead, or in a wheel chair or other chair, in which the projector is on the seat between the legs of the user.

It should be noted that the embodiment of FIG. 5 in the curved portion of an instrument panel in front of the passenger, may also be thought of in the curved arm of an arm chair, where a person seated in the chair may operate computer systems by touching a screen/control surface in the curved arm, or by actuating a physical control on the surface. Such a system might be a remote control for a TV for example.

The invention herein applies for the control of anything where the projection and sensing element is desirably separated from the user interface element of the invention. This can include controls outside clean rooms, nuclear facilities and the like, with windows or free space separating the two elements.

FMVSS 101 is contained in USA CFR Title 49 part 571. “Light” as used herein includes all electromagnetic wavelengths from ultraviolet to near infrared.

With respect to figure is 29 it should be noted that the choice between one or the other states of the display and controls (for example audio or climate as shown) can be made using buttons or other controls on the steering wheel, which are quite convenient for the driver. It is contemplated that the buttons themselves, or other buttons on the steering wheel indeed could also reconfigure their functions, depending for example on the choice of whether the audio or the climate selection was made. For example, if I the driver press climate as we have shown it, substantially the whole center stack screen and display can if desired be programmed to display the various controls for the heating and air conditioning, or any other choice, programmed—either at the factory or by the user himself. In any case it would be useful than that buttons on the steering wheel that might of at one point been used to change volume or station with respect to the a radio portion of the vehicle would in the climate control mode change their function to for example temperature and fan speed. By having these buttons reconfigure, fewer are needed on the steering wheel and the resulting steering wheel buttons can be larger and less confusing to the driver.

It is also possible that one might choose to have the buttons on the steering wheel operate in an opposite manner from the state of the center stack display and controls. For example, if one used a button on the center stack such as shown in FIG. 29 to change let us say the state of the center stack controls to the climate condition, one might purposely leave some steering wheel controls in the audio mode so that you would then have steering wheel controls to keep operating the basic functions of your audio system while you use the center stack in detail to set up your climate system, which of course you would be able to do given the large amount of data that can be manipulated and presented on the center stack using the invention. It is possible that the operator can be given the choice of whether what sorts of ways of operating the system he prefers pointed out in other applications.

It is possible to use a DLP or other 2-axis light valve type projector to do the sensing task as well. This typically provides a lower cost solution and one which shares a common optical path I have found an improvement to what I've described previously can be made in this context using the projector to also function as a center where speed can be attained sufficient to both project and sense without the loss of image quality provides. In this example, it is useful to modulate the light source, either the visible LEDs or diode lasers of the projector or an auxiliary infrared LED or diode laser, in order to achieve a discrimination against ambient light using time based or frequency based detection techniques. In this particular case, the image elements of the image engine DLP or LCD or LCOS for example provide the ability to determine where on the screen and control surface the information is coming from and therefore locate a touch on the screen or a control position such as a rotational location of the knob.

I also found another a good way to change the state of the control surface in screen (for example in FIG. 29 from audio system to climate control system) is to have one of the knobs preferably the one closest to the driver simply also function as a push switch. For example, if you're in a temperature in an a climate control mode and your hand is on the temperature knob, which is closest to you and you push it in that can very conveniently cause the system to change to audio system in which case the knob now represents volume which is also the typical thing you would seek to change in an audio mode. In other words, you can do it all in one motion from the thing most changed in climate to the thing most changed in audio the volume, changing the rest of the control surface and screen at the same time.

The embodiment of FIG. 17 has illustrated what I believe is a novel and useful embodiment for persons in bed or other locations such as car seats where it may be desirable to have no physical connection between the screen/control surface and the projector and sensor unit (and associated computer, communication devices and the like. The bed application can be it in ones normal bed at home or confined to a hospital bed, which is the example shown and is particularly germane given the problem of cleaning devices which patents hold in their hands such as tv remote control units.

The goal is to provide both useful information and amusement to the patient, who as shown in FIG. 17 is able to hold a screen and control surface in his hand. This as discussed can be held in free space without a support since it is generally simply plastic and can be quite light. As pointed out in a very big advantage is that it can also be easily washed since this is the thing that gets most dirty through patient use. Alternatively, of course there can be brackets or other means used to sturdy the screen. Side rails or posts of the bed can be used to clamp the screen bracket to for example. The system also has an advantage that no wires or wireless transmission need connect the device in the patients hand, thus making it safer to use around sophisticated instrumentation such as heart monitors.

In other applications I've pointed out one can photgrammetrically determine position and orientation of the screen in free space using the sensor of the projector or a separate sensor if used, typically located in this invention in the same housing as the projector.

These targets such as 1730, 1731 etc are viewed by the sensing system of the projector. Dynamically this data may be taken into the computer and utilized to correct the projection of information onto the screen so as to account for angular rotation and movement in and out by the patient of the screen toward the projector along the optical axis of the projector. For example, the image can either be caused to rotate with the screen to stay lined up on the screen or it can stay stationary and simply utilize the information gathered from the screen to cause the projector not to project past the edge of the screen if desired so as to not project into the eyes of the user for example. In this case it means that some of the image would be cut off, if the screen were rotated. The potential of z-axis movement means that the magnification of the image on the screen can vary. Conversely, one can choose to keep the is area of the projected image constant on the screen, which means that as one moves in and out certain areas would either be lost around the edges or conversely be a have a dead space around the edges.

The sensor unit sensing the position of the screen also performs another function, and that is, to determine the location of the patient's fingers or objects held by the patient such as a pen on the screen or certain controls it may be on the screen such as knob 1725. In this case the measurements taken are taken at relative to the screen through the use of the target datum's on the knob and the screen. These measurements in turn need to be corrected. However, if the image projection is being caused it to rotate or otherwise move on the screen, the knowledge of where a correct touch for example, corresponds to the actual projected image needs to be obtained by the computer.

The invention is extremely useful for hospital application because of the lightweight easy to clean interface for the patient. And there is no need to transmit wireless signals from the interface, which could confuse sensitive monitoring equipment. The users desires are optically transmitted to the computer of the device (in this case shown in the foot of the bed), which can then communicate over wires if necessary to any other device such as central computer of the hospital, a TV set on a wall, or whatever. And TV signals can be directed to the computer controlling the projector of the device in the bed in a similar manner. There really is no need for a wall mounted TV at all. Sound can be provided to the user from a small amplifier and speaker located on bed side, which also be provided with earphones if needed to avoid disturbing other patients.

In the rear seat display screen situation of FIG. 5b for example it is possible to have a screen such as 545 instead located in the headrest of the seat in front of the rear seat passenger, rather than in the front seat itself. A video projector located in the seat proper illuminates the screen, and data inputs of the passenger on the screen or control associated with it are optionally sensed according to the invention. Such data can be related to internet addresses if the unit is used for searching, commands to change entertainment information such as DVDs or video clips, or the like.

This design is also conducive to safety in the event of an accident. The headrest for example can move forward in the fore aft direction of the vehicle (perhaps using a pyrotechnic charge) to better support the person's head, while the projector, sensor and electronic components remain in the seat proper, the head rest moving generally perpendicular to the optical path of the projector and sensor (if an optically based touch sensor is used). Thus only plastic parts need be contained in the headrest itself, and these may be as soft as desired for safety purposes. This includes not only the screen and control surface, but any knobs or push switches that might be attached thereto.

The invention has been described in connection with numerous embodiments, it is to be understood that the specific mechanisms and techniques that have been described are merely illustrative of the principles of the invention, and numerous modifications may be made to the methods and apparatus described without departing from the spirit and scope of the invention.

1. A method for providing video images and an interface thereto for persons in a vehicle seated behind a seat in front of them, comprising the steps of;
providing a video image projector in the seat ahead of said person;
projecting data from the projector is the onto a screen associated with the seat or the head rest of the seat ahead of the person;
sensing information concerning finger or control location on the screen; and
determining from said information, controlling images projected by said projector.

2. A method according to claim 1 wherein said images are obtained via the Internet.

3. A method according to claim 1 wherein said screen is plastic.

4. A method according to claim 1 wherein the surface of the screen is curved in at least some areas.

5. A method for presenting a larger size video image than would normally be possible in a constrained housing area in which physical controls are also present, comprising the steps of:
providing physical control details such as knobs or switches within the screen area of a screen substantially occupying said constrained housing area, and
displaying an image which is viewable both around and within said control details, such that an observer of said image perceives an adequate view even though relatively small portions of the image are blocked by portions of said physical control details, wherein said constrained housing area is a center stack of a motor vehicle.

6. A method for providing increased visibility of projected labels on control panels such as those of a vehicle instrument panel comprising the step of changing a projection variable related to said label, said change not being applied to a larger display area of which the label is a part.

7. A method according to claim 6 wherein said variable is a label color.

8. A method according to claim 6 wherein said variable is light source power.

9. A method according to claim 6 wherein said variable is the dwell time of projection of label information.
